(19) United States
(12) Patent Application Publication
(10) Pub. No.: US 2011/0090433 A1
(43) Pub. Date: Apr. 21, 2011

(54) LIQUID CRYSTAL DISPLAY DEVICE

(76) Inventors: Kazuyoshi Sakuragi, Osaka (JP); Nobuaki Yamada, Osaka (JP); Kazuhiko Tsuda, Osaka (JP); Akira Sakai, Osaka (JP)

(21) Appl. No.: 12/999,136

(22) PCT Filed: Apr. 7, 2009
(86) PCT No.: PCT/JP2009/057112

§ 371 Date: Dec. 15, 2010

(30) Foreign Application Priority Data
Jul. 2, 2008 (JP) 2008-173953

(51) Int. Cl. G02F 1/1335

(52) U.S. Cl. 349/96

(57) ABSTRACT

A TN liquid crystal display device (1) includes a polarizing plate (4a), a liquid crystal panel (100), and a polarizing plate (4b) in an order from a viewer side, in which absorption axes (4α and 4β) of the polarizing plates (4a and 4b) are set to be at an angle of approximately 45 degrees to respective rubbing directions (6a and 6b) of a first substrate (2a) and a second substrate (2b), and the absorption axes (4α and 4β) are arranged so as to be perpendicular to each other. Further, for example, a biaxial phase plate (5a) is provided at least between the substrate (2a) and the polarizing plate (4a) so that an in-plane slow axis (5α) is set to be at an angle of approximately 90 degrees to the absorption axis (4α) of the polarizing plate (4a). This configuration makes it possible to realize, at a low cost, a technique to concurrently improve (i) a viewing angle display characteristic and (ii) use efficiency of material members of the TN display liquid crystal display device.

### TECHNICAL FIELD

The present invention relates to a liquid crystal display device which (i) including an optical member which can be produced with small loss and effectively used at a low cost, and (ii) has excellent display properties. More specifically, the present invention relates to a TN display liquid crystal panel which employs a polarizing plate system with a general-purpose phase plate so as to (i) improve area use efficiency of a member, (ii) control a reversal phenomenon in a halftone, and (iii) improve a characteristic of contrast ratio to viewing angle.

### BACKGROUND ART

Liquid crystal display devices have been used in a wide range of fields by taking advantage of features such as lightweight, slimness, and low power consumption. A twisted nematic (TN) mode is known as one of display modes which are most widely used in liquid crystal panels so far.

According to such a TN display liquid crystal panel, in general, nematic liquid crystal (Np liquid crystal) having a positive dielectric anisotropy is filled, as a liquid crystal layer, between a pair of substrates. In a state where a voltage applied between the upper and lower substrates is lower than a threshold voltage, liquid crystal molecules are oriented substantially in parallel with faces of the substrates and twisted at approximately 90 degrees from one of the substrates toward the other of the substrates.

In a case where a pair of polarizing plates are provided on respective outer sides of the upper and lower substrates (on a viewer side and an opposite side) in a crossed Nicols arrangement, the liquid crystal panel carries out a white display in the state where a voltage which is lower than the threshold voltage is being applied (including a state where no voltage is applied). On the other hand, in a state where a voltage equal to or higher than the threshold voltage is being applied between the upper and lower substrates, the liquid crystal molecules are oriented in a direction substantially vertical to the substrates, and their twisted orientations are cancelled. This allows a black display (normally white display) to be realized.

For the TN display liquid crystal panel, a relatively cheap production technique has already been established, and the TN display liquid crystal panel is industrially matured. However, an object of realizing an isotropic display property has not been attained yet. In particular, according to a conventional technique in which a polarizing plate without a phase plate is used, a contrast ratio is decreased in impressing an electric field, and display quality is deteriorated due to a gradation reversal phenomenon which occurs in a halftone.

In order to improve the above described gradation reversal phenomenon in the TN display liquid crystal panel, a method is commonly know in which the liquid crystal panel is optically designed based on assumption that a so-called twelve o'clock direction (an upward direction in a case where a display face is assumed as a dial plate) of the liquid crystal panel which is disposed in front of a viewer is regarded as a normal viewing angle direction.

According to the configuration, it is necessary to (i) provide a substrate, which has been subjected to a rubbing process in +45 degrees direction, as the upper substrate (viewer side), (ii) provide a substrate, which has been subjected to a rubbing process in +315 degrees direction, as the lower substrate, and (iii) provide a levorotatory liquid crystal layer between the upper and lower substrates, where a counterclockwise direction is a forward direction in a rotating coordinate system in which a direction pointing the right (so-called three o'clock direction) with respect to the screen of the liquid crystal panel is 0 degree.

Moreover, in order to obtain a maximum transmittance of the TN display liquid crystal panel which is in a white display, (i) each of absorption axes of the respective upper and lower polarizing plates needs to be in parallel with a rubbing direction of a corresponding one of the upper and lower substrates or (ii) each of the absorption axes needs to be perpendicular to a rubbing direction of a corresponding one of the upper and lower substrates.

Techniques for attaining a high contrast ratio have been keenly developed for the above described TN display liquid crystal panel which carries out a normally white (NW) display.

(Prior Art 1)

Patent Literature 1 cited below discloses a liquid crystal display device in which a viewing angle and a gradation reversal phenomenon of a TN display liquid crystal panel are improved (see FIG. 17 illustrating a schematic view).

According to the technique, a liquid crystal panel 100 includes an upper substrate 20a; a lower substrate 20b; and a pair of an upper polarizing plate 40a and a lower polarizing plate 40b which are provided on respective outer sides of the upper and lower substrates 20a and 20b so that absorption axes 40α and 40β of the respective polarizing plates 40a and 40b are set to be at an angle of approximately 45 degrees with respect to respective rubbing directions 60a and 60b of the upper and lower substrates 20a and 20b. Further, biaxial phase plates 50a and 50b are respectively provided (i) between the upper substrate 20a and the polarizing plate 40a and (ii) between the lower substrate 20b and the polarizing plate 40b.

Note that the biaxial phase plates 50a and 50b has respective in-plane slow axes 50α and 50β each of which extends in an in-plane direction of a corresponding one of the biaxial phase plates 50a and 50b. The in-plane slow axis 50α is set to be in parallel with the absorption axis 40α of the polarizing plate 40a and the in-plane slow axis 50β is set to be perpendicular to the absorption axis 40β of the polarizing plate 40b. The in-plane slow axes 50α and 50β of the respective biaxial phase plates 50a and 50b are set to be substantially in parallel with each other.

In particular, one of features disclosed in Patent Literature 1 is that the in-plane slow axes 50α and 50β of the respective biaxial phase plates 50a and 50b which are provided on the upper and lower substrates 20a and 20b are substantially in parallel with each other.

(Prior Art 2)

On the other hand, Patent Literature 2 cited below discloses a technique to reduce a gradation reversal phenomenon in a halftone display of a TN display liquid crystal panel and realize a high contrast ratio. According to the technique, polarizing plates which are provided on respective upper and lower substrates of the liquid crystal panel have respective absorption axes (i) which are perpendicular to each other and (ii) each which is set to be at an angle of approximately 45 degrees with respect to a direction of an orientation process (rubbing direction) on a surface of a corresponding one of the upper and lower substrates. Moreover, a technique is proposed in which (i) a viewing angle compensating film (Wide View Film (manufactured by Fuji Photo Film Co., Ltd.)) which includes a discotic liquid crystal phase or (ii) a uniaxial phase plate is further provided in order to control a gradation reversal phenomenon and to further improve a viewing angle characteristic. The introduction of these optical films contributes to drastically improve display performance.

### CITATION LIST

### Patent Literature

Patent Literature 1
Japanese Patent Application Publication, Tokukaihei, No. 7-120746 (Publication Date: May 12, 1995)
Patent Literature 2
Japanese Patent Application Publication, Tokukai, No. 2006-285220 (Publication Date: Oct. 19, 2006)

### SUMMARY OF INVENTION

### Technical Problem

However, various problems occur when the conventionally disclosed techniques are used in order to realize, at low cost, a simpler technique (i) to improve a viewing angle characteristic of a TN display liquid crystal display device and (ii) to suppress a decrease of a contrast ratio in impressing an electric field.

(Liquid Crystal Display Principle in TN Display Mode)

The following describes a display principle of a TN display liquid crystal display device with reference to FIG. 18. While no voltage is applied or a voltage lower than the threshold voltage is being applied, liquid crystal molecules on boundary surfaces of respective upper and lower substrates 20a and 20b are oriented along rubbing directions 60a and 60b which are set to cross at an angle of approximately 90 degrees on the respective upper and lower substrates 20a and 20b. This allows a twisted orientation to be realized in which the liquid crystal molecules are twisted at approximately 90 degrees in a cell thickness direction (see (a) of FIG. 18).

The liquid crystal panel described above is referred to as a liquid crystal panel 100 in this explanation. According to the liquid crystal panel 100, a pair of polarizing plates 40a and 40b are provided on outer sides of the respective upper and lower substrates 20a and 20b which are disposed on a viewer side and an opposite side so that absorption axes 40α and 40β of the respective polarizing plates 40a and 40b are arranged in a crossed Nicols arrangement. When light enters the liquid crystal layer via the polarizing plate 40b, the light (i) becomes linearly polarized light, (ii) travels in the liquid crystal layer while being twisted along molecule orientations in accordance with optical rotation property of the liquid crystal molecules 30, and (iii) permeates the polarizing plate 40a on the viewer side. This allows the liquid crystal panel 100 to carry out a white display.

On the other hand, while a voltage which is equal to or higher than the threshold voltage of the liquid crystal layer is being applied between the upper and lower substrates 20a and 20b, a transmissive light amount is decreased because the twisted orientations are cancelled due to dielectric anisotropy of the liquid crystal molecules 30. Moreover, while a voltage which is equal to or higher than a saturation voltage is being applied, the liquid crystal molecules 30 are oriented in a direction substantially vertical to the surfaces of the substrates in the center of the liquid crystal layer (see (b) of FIG. 18). This causes a loss of the optical rotation property. From this, an optic element of linearly polarized light which has entered via the polarizing plate 40b is absorbed by the polarizing plate 40a which is disposed on an emitting side. This causes the liquid crystal panel 100 to carry out a black display.

Note that each of the liquid crystal molecules in the liquid crystal panel has (i) a bar-like structure and (ii) refractive index anisotropy in which refractive indexes are different in a major axis direction and a minor axis direction of the molecule. This causes birefringence in polarized light, and a viewing angle characteristic varies because a degree of the birefringence changes depending on at which angle and in which direction the molecules are viewed. Note that, in a case where the major axis direction is defined as a z-axis direction in an xyz orthogonal coordinate system, the minor axes directions are defined as an x-axis direction and a y-axis direction.

In general, a liquid crystal molecule shows a positive uniaxial refractive index in which a refractive index in the major axis direction is larger than refractive indexes in the two minor axis directions. When the liquid crystal molecule is viewed in the major axis direction, the birefringence becomes substantially 0. On the other hand, when the liquid crystal molecule is viewed from a lateral side, the birefringence becomes a maximum.

According to an actual liquid crystal display device, an orientation state of a liquid crystal molecule changes in accordance with intensity of an applied voltage or a direction in which the liquid crystal panel is viewed, and therefore an apparent birefringence varies. This causes a deterioration of a display characteristic of a common liquid crystal panel. Such a deterioration of the display characteristic can be, for example, (i) a decrease of a contrast ratio in a black display state, (ii) a gradation reversal in halftone, or (iii) a decrease of a viewing angle characteristic in an oblique direction.

### Problems of Prior Art, Etc

According to Prior Art 1, biaxial phase plates 50a and 50b are respectively provided adjacent to the polarizing plates 40a and 40b. The biaxial phase plate 50a has the in-plane slow axis 50α which is substantially in parallel with the absorption axis 40α and the biaxial phase plate 50b has the in-plane slow axis 50β which is substantially perpendicular to the absorption axis 40β. The in-plane slow axes 50α and 50β are substantially in parallel with each other. In this way, the TN display liquid crystal panel 100 is configured. The configuration of Prior Art 1 brings about (i) a new problem as to an optical characteristic and (ii) a problem that costs of materials and members cannot be sufficiently reduced, as described below.

The term “in-plane slow axis” is an axis which (i) is one of crystal axes defined in a birefringent medium such as a stretching phase plate and (ii) extends in an in-plane direction in which a speed of light traveling in the medium becomes relatively slow. Specifically, (a) of FIG. 19 illustrates a classification chart of multiaxial stretching phase plates for example. In a case where (i) a direction in which an in-plane refractive index becomes a maximum in each of the phase plates is defined as an x-axis, (ii) a direction perpendicular to the x-axis is defined as a y-axis, and (iii) a thickness direction of each of the phase plates is defined as a z-axis, refractive indexes of respective directional components are referred to as main refractive indexes nx, ny, and nz at 25° C., which correspond to the x-axis, the y-axis, and the z-axis, respectively.

Note that (b) of FIG. 19 illustrates, as an ellipsoidal body of refractive indexes, a magnitude relation of the main refractive indexes nx, ny, and nz of the biaxial phase plate. Such a biaxial phase plate is generally manufactured through biaxial stretching so as to have a slow axis along which a refractive index becomes large in a direction of the biaxial stretching.

(Problem 1)

According to the method of Prior Art 1, in a case where polarizing plates each of which is provided with a biaxial phase plate are used as the polarizing plates 40a and 40b, an optical axis arrangement relation between the in-plane slow axis 50α and the absorption axis 40α of the upper polarizing plate 40a is different from an optical axis arrangement relation between the in-plane slow axis 50β and the absorption axis 40β of the polarizing plate 40b (see FIG. 17). Accordingly, it is necessary to use members which have been subjected to respectively different manufacturing processes, in order to produce the polarizing plates which are provided with respective biaxial phase plates. This leads to an increase of processes during manufacturing, and thereby it is not possible to attain the object of reducing costs by efficiently using the members which are mainly dealt with in the present invention.

(Problem 2)

According to the method of Prior Art 1, an arrangement relation between the absorption axis 40α and the in-plane slow axis 50α is different from an arrangement relation between the absorption axis 40β and the in-plane slow axis 50β, on respective upper and lower sides of the liquid crystal panel 100. Accordingly, it might be rather difficult to improve right and left viewing angle characteristics with good symmetry. It is important to improve the right and left viewing angle characteristics of the liquid crystal panel 100 with good symmetry in order to deal with a case where a single display screen is viewed by many people from right and left.

Moreover, in a case where display quality of the TN display liquid crystal panel is improved with the method of Prior Art 2, an optical film having a special function needs to be stacked on the polarizing plate. This causes a layer thickness of the members to be increased and also costs of the members are increased.

Further, according to the conventional TN display liquid crystal panel, a pair of polarizing plates which are to be provided on the liquid crystal panel need to be clipped out from a polarizing plate film roll after the polarizing plate film roll is rotated in +45 degrees direction and +135 degrees direction with respect to a direction in which the polarizing plate film roll is stretched. Accordingly, there has been an apparent problem that an angular error occurs in the polarizing plates.

Besides, in the production (the clipping out process) of the conventional polarizing plate, some areas of the sheet-like polarizing plate film are not used because the film is rotated at an angle such as +45 degrees during the clipped out process (see FIG. 20). Accordingly, the area of the whole polarizing plate film roll is to be used less efficiently. As a result, a problem has remained that costs of the members cannot be reduced sufficiently.

The present invention is accomplished in view of the various problems apparent in the TN display liquid crystal panel, and its object is to provide a liquid crystal display device in which, with a simpler method and low cost, (i) a viewing angle characteristic is improved and (ii) a decrease of contrast when an electric field is impressed is controlled.

### Solution to Problem

A liquid crystal display device of the present invention is a TN display liquid crystal panel in which (i) an upper side of the liquid crystal display device is disposed on a viewer side, and (ii) a first polarizing plate, a liquid crystal cell, and a second polarizing plate, are provided in this order. Further, a predetermined biaxial phase plate(s) is provided between at least one of the first and second polarizing plates and a corresponding substrate. In order to improve properties of the liquid crystal panel such as a luminance characteristic, a contrast ratio, and a viewing angle characteristic, each of the absorption axes of the polarizing plates and an in-plane slow axis of the biaxial phase plate(s) are set in consideration of a relation with a rubbing direction of a corresponding substrate. Further, an optical design such as a phase difference in the liquid crystal panel is also considered. In this way, the above described various problems are solved.

In particular, the object of the present invention is to deal with the problems by further improving and optimizing arrangements of the absorption axes of the polarizing plates and the in-plane slow axes of the biaxial phase plates of the above described Prior Art 1.

According to the method of Prior Art 1, the polarizing plate and the biaxial phase plate which are provided on the viewer side respectively have the absorption axis and the in-plane slow axis which are in parallel with each other. With this alignment, a viewing angle characteristic still cannot be improved with good symmetry.

It is extremely important to arrange the in-plane slow axis of the biaxial phase plate at approximately 90 degrees (right angle) to the absorption axis of the polarizing plate, in order to efficiently improve the problem of the viewing angle characteristic while a contrast ratio and a viewing angle characteristic in a frontward direction of the liquid crystal panel are not decreased.

This is because the following two conditions need to be satisfied concurrently.

A first condition (1) is that birefringence of the biaxial phase plate does not occur in the frontward direction so that a contrast ratio in the frontward direction is not decreased. A second condition (2) is that the birefringence of the biaxial phase plate becomes effective in an oblique direction in order to carry out a viewing angle compensation.

In order to satisfy the first condition (1), a relation between the in-plane slow axis of the biaxial phase plate and the absorption axis of the polarizing plate needs to fall under any of the following configurations (1-1) and (1-2):

(1-1) When the plates are viewed in a frontward direction, the absorption axis and the in-plane slow axis are in parallel with each other (as shown in (a) of FIG. 6; an absorption axis a(o) and an in-plane slow axis e1(o) are in parallel with each other);
(1-2) When the plates are viewed in a frontward direction, the absorption axis and the in-plane slow axis are perpendicular to each other (as shown in (a) of FIG. 7; an absorption axis a(o) and an in-plane slow axis e1(o) are perpendicular to each other).

Moreover, in order to satisfy the second condition (2), the configuration (1-2) needs to be satisfied. This is because, in a case where light enters a stacked plate including the polarizing plate and the biaxial phase plate from an oblique direction, birefringence of the biaxial phase plate is not substantially effective at all in the oblique direction when an effective transmission axis (t) of the polarizing plate viewed in the oblique direction is in parallel with one of vibration directions of two natural vibration modes of the biaxial phase plate with respect to the incoming light from the oblique direction. In order for the birefringence to be effective in the oblique direction, the substantial transmission axis of the polarizing plate viewed in the oblique direction needs to be arranged so that the substantial transmission axis is neither in parallel with nor perpendicular to any of vibration directions of natural polarization modes of the biaxial phase plate.

In a case where the absorption axis of the polarizing plate is in parallel with the in-plane slow axis of the biaxial phase plate as in the case of the configuration (1-1), the effective transmission axis of the polarizing plate viewed in any direction is in parallel with one of vibration directions of the two natural vibration modes of the biaxial phase plate (see (b) of FIG. 6), and thereby the birefringence does not function effectively.

On the other hand, in a case where the absorption axis of the polarizing plate is perpendicular to the in-plane slow axis of the biaxial phase plate as in the case of the configuration (1-2), the effective transmission axis of the polarizing plate viewed in the oblique direction visually appears not to be in parallel with or perpendicular to the vibration directions of the natural polarization modes of the biaxial phase plate (see (b) of FIG. 7), and thereby the birefringence functions effectively.

For the reasons above, it is extremely important to employ the alignment in which the absorption axis of the polarizing plate and the in-plane slow axis of the biaxial phase plate are perpendicular to each other, in order to improve a contrast ratio and a viewing angle characteristic with good balance.

Note that the present invention presupposes that the polarizing plate is a so-called O-type (ordinary light refractive index) polarizer in which, for example, an anisotropic material such as a dichroic iodine complex is adsorption-aligned on a PVA (polyvinyl alcohol) film. The O-type polarizer is a polarizer which absorbs light vibrating in a particular direction (defined as an absorption axis) in an element plane of the polarizer, and which allows (i) light vibrating in a direction (defined as a transmission axis) perpendicular to the absorption axis in the element plane and (ii) light vibrating in a normal direction of the element to penetrate the O-type polarizer. That is, the O-type polarizer is a polarizer which has a single absorption axis and two transmission axes. An optical axis of the O-type polarizer is directed along the absorption axis.

Note that the “optical axis” of the birefringent layer indicates a main axis corresponding to a main refractive index which has a maximum absolute value of difference from an average among three main refractive indexes of the birefringent layer (in the case of (b) of FIG. 19, the optical axis is the x-axis).

Moreover, in a case where a biaxial phase plate having birefringence of nx>ny≧nz is provided, the birefringence becomes equal to uniaxial birefringence when ny=nz is satisfied, and the in-plane slow axis becomes an optical axis. In a case where ny>nz is satisfied, the optical axis is also set to be in parallel with the in-plane slow axis.

According to the present invention, the polarizing plate is stacked on the biaxial phase plate having birefringence of nx>ny≧nz so that the in-plane slow axis of the biaxial phase plate is set to be at an angle of approximately 90 degrees with respect to the absorption axis of the polarizing plate. This makes it possible to improve a contrast ratio and a viewing angle characteristic in a frontward direction of the liquid crystal panel.

The present invention is proposed for solving various problems such as leakage of light, a decrease of a contrast ratio, and a deterioration of a viewing angle characteristic which occur due to birefringence in a black display state while a voltage is being applied in a general TN display liquid crystal display device. The inventors of the present invention diligently studied and found that the above described problems can be solved by providing a TN display liquid crystal display device with a biaxial phase plate, which is conventionally widely used in a vertical alignment (VA) liquid crystal display device in order to improve a display characteristic in a black display state. In this way, the present invention is accomplished.

More specifically, the following describes main features of the present invention.

A liquid crystal display device of the present invention includes: a pair of a first substrate and a second substrate, the first substrate being provided on a viewer side; a liquid crystal layer which is provided between the first substrate and the second substrate, the liquid crystal layer being a twisted nematic liquid crystal layer which has substantially 90-degree twist, in a thickness direction, between the first substrate and the second substrate; a pair of a first polarizing plate and a second polarizing plate having respective absorption axes which are perpendicular to each other, the first polarizing plate and the second polarizing plate being provided on outer sides of the respective first and second substrates; and a biaxial phase plate which is provided between the first polarizing plate and the second polarizing plate, the biaxial phase plate including first and second biaxial phase plates which are provided for the respective first and second polarizing plates so that their in-plane slow axes are substantially perpendicular to each other, the absorption axis of the first polarizing plate being set to be at an angle of substantially 90 degrees to an in-plane slow axis of the first biaxial phase plate, and the absorption axis of the second polarizing plate being set to be at an angle of substantially 90 degrees to an in-plane slow axis of the second biaxial phase plate.

The configuration makes it possible to solve, with a relatively simple and cheap configuration, the conventional problems of display quality such as the occurrence of a gradation reversal phenomenon in a halftone and a poorly symmetrical viewing angles, in the TN display liquid crystal panel which have been industrially matured based on generally established production techniques.

According to another configuration of the present invention, a TN display liquid crystal panel includes a biaxial phase plate which is provided at least one of (i) between the first substrate and the first polarizing plate and (ii) between the second substrate and the second polarizing plate, an in-plane slow axis of the biaxial phase plate being set to be at an angle of substantially 90 degrees to an absorption axis of a corresponding one of the first polarizing plate and the second polarizing plate on which the biaxial phase plate is provided.

According to the configuration, for example, (i) a conventional polarizing plate with a biaxial phase plate which has been designed for use in a liquid crystal television, etc., and (ii) a general-purpose linear polarizing plate can be used together. This provides a great advantage of improving, at low costs, display quality of the TN display liquid crystal panel by using an optical member which has been produced and distributed as a general-purpose product.

In particular, in a case where a biaxial phase plate is provided on only the outer side of the second substrate which is opposite to a viewer, a TN display liquid crystal panel can be provided in which a gradation reversal in a halftone display is controlled, and viewing angles are excellently symmetric. That is, the liquid crystal display device in which display quality is improved with a simple configuration can be realized.

According to the configuration of the present invention, a viewing angle characteristic is improved, as compared with a case where a biaxial phase plate is not used.

Moreover, according to another configuration of the present invention, (i) a biaxial phase plate is provided between an outer side of at least one of the substrates and a polarizing plate which is provided for the corresponding substrate so that an in-plane slow axis of the biaxial phase plate and an absorption axis of the adjacent polarizing plate form an angle of approximately 90 degrees, and besides the feature, the absorption axis of the first polarizing plate is set to be at an angle of substantially 45 degrees to a rubbing direction of the first substrate; and the absorption axis of the second polarizing plate is set to be at an angle of substantially 45 degrees to a rubbing direction of the second substrate.

According to the configuration, the polarizing plates on which the biaxial phase plates are respectively stacked and which have the same specification can be provided on respective outer sides of the upper and lower substrates of the liquid crystal panel. This makes it possible to realize a technique to improve a contrast ratio and a viewing angle characteristic of the TN display liquid crystal display device. According to the configuration, a set of upper and lower polarizing plates with respective phase plates can be produced by clipping out, with respective sizes fitting with an outer shape of the liquid crystal panel, a polarizing plate roll having the same specification which has been produced through a process of stacking a predetermined phase plate film on a polarizing plate film. This is extremely advantageous in view of reduction of material costs.

According to the configuration, the problem in clipping out the original polarizing plate roll can be solved, concurrently with improvement in use efficiency of a film area, as well as improvement in display quality. This is the great feature of the configuration.

According to the conventional TN display liquid crystal display device of a twelve o'clock viewing angle (a wide viewing angle direction is an upward direction with respect to a front face of the liquid crystal panel), it is necessary to carry out the clipping out process after rotating the polarizing plate film in +45 degrees direction and +135 degrees direction, where a counterclockwise direction is a forward direction in a rotating coordinate system in which a direction pointing the right (three o'clock direction) of the screen is a reference direction at 0 degree. In the clipping out process on the film, an angular error occurs. Further, in providing the polarizing plates on the liquid crystal panel, an angular error occurs between the polarizing plates due to an error in positional accuracy etc. These errors cause a display contrast ratio to be decreased.

On the other hand, according to the configuration of the present invention, a direction of a clipped edge face of the polarizing plate roll can be conformed to that of an edge face of the substrate in the liquid crystal panel having a rectangular outer shape. This makes it possible to mostly prevent an angular error caused in clipping out the upper and lower polarizing plates.

The direction of the clipped edge face of the polarizing plate film roll can be conformed to that of the edge face of the substrate because a length direction of the belt-like film of the original polarizing plate roll conforms to the absorption axis direction. From this, area use efficiency can be drastically improved, as compared with the case where the clipping process is carried out on the film roll which is rotated in, with respect to its stretched direction, +45 degrees direction and +135 degrees direction. Accordingly, material costs can be drastically reduced.

Moreover, according to the liquid crystal display device in which the biaxial phase plate is further provided between the second substrate and the second polarizing plate, a symmetrical property of viewing angle characteristics in right and left directions is improved, as compared to the case where the biaxial phase plate is provided only on the first substrate side which is the upper side of the liquid crystal panel.

Note that the display characteristic can be further improved in a case where the biaxial phase plate of the present invention has (i) an in-plane phase difference R₀ which falls within a range between 45 nm and 65 nm, the in-plane phase difference R₀ being defined by Formula 1 below and (ii) a normal phase difference Rₜₕ in a thickness direction which normal phase difference Rₜₕ falls within a range between 115 nm and 135 nm, the normal phase difference Rₜₕ being defined by Formula 2 below.

R₀=(nx−ny)·d (Formula 1)

Rₜₕ={(nx+ny)/2−nz}·d (Formula 2)

where x and y are in-plane directions of the biaxial phase plate which are perpendicular to each other; z is a thickness direction of the biaxial phase plate; nx, ny, and nz are main refractive indexes, at 25° C., for the respective directions x, y, and z; and d (nm) is a thickness of the biaxial phase plate.

This is because a gradation reversal phenomenon in a halftone remarkably tends to occur unless the in-plane phase difference R₀ and the normal phase difference Rₜₕ in the thickness direction fall within the above respective ranges. In particular, in a case where a phase difference does not fall within a set range, leakage of light tends to become large in quantity during displaying of a black tone. This causes a gradation reversal to occur in a narrower range.

Moreover, in a case where the liquid crystal layer used in the liquid crystal display device of the present invention has a phase difference in a range between 400 nm and 470 nm at 25° C. and with a wavelength of 550 nm, relative transmittance and display characteristics such as color reproductivity and a tinge of the liquid crystal display device can be comprehensively improved, and a relatively excellent display can be achieved without deteriorating a luminance characteristic and color tone variations.

### ADVANTAGEOUS EFFECTS OF INVENTION

As described above, a liquid crystal display device of the present invention is a TN display liquid crystal panel including a first polarizing plate, a liquid crystal cell, and a second polarizing plate which are provided in this order from the viewer side. Further, a predetermined biaxial phase plate(s) is provided between at least one of the first and second polarizing plates and a corresponding substrate. In order to improve properties of the liquid crystal panel such as a luminance (transmittance) characteristic, a contrast ratio, and a viewing angle characteristic, each of the optical axes of the component films are set in consideration of a relation with a rubbing direction of a corresponding substrate.

The configuration makes it possible to solve, with a relatively simple and cheap configuration, the conventional problems of display quality such as the occurrence of a gradation reversal phenomenon in a halftone and a poorly symmetrical viewing angles, in the TN display liquid crystal panel which have been industrially matured based on generally established production techniques.

According to the configuration, a general-purpose polarizing plates) with a biaxial phase plate is provided on one of or respective outer sides of both the substrates of the TN display liquid crystal panel so that each predetermined optical axis is set based on a relation with a corresponding rubbing direction in the liquid crystal panel. This makes it possible to (i) solve the above described problems of display properties, and also (ii) drastically improve area use efficiency in clipping out the polarizing plate with the biaxial phase plate from the polarizing plate roll.

### BRIEF DESCRIPTION OF DRAWINGS

FIG. 1

FIG. 1 is a perspective view schematically illustrating a configuration example of a liquid crystal display device of the present invention: (a) illustrates a case where biaxial phase plates are provided on upper and lower sides of a liquid crystal panel; (b) illustrates a case where a biaxial phase plate is provided on only the lower side of the liquid crystal panel; and (c) illustrates a case where a biaxial phase plate is provided on only the upper side of the liquid crystal panel.

FIG. 2

FIG. 2 is an explanatory view regarding alignments of absorption axes, in-plane slow axes, and rubbing directions in the liquid crystal display device of the present invention: (a) through (c) illustrate various modifications.

FIG. 3

FIG. 3 is a principle view giving an outline of an improvement effect in an optical characteristic in a case where a system of the present invention in which a polarizing plate is provided with a biaxial phase plate is used.

FIG. 4

FIG. 4 is a graph illustrating a relation between a phase difference of a liquid crystal layer and a relative transmittance (frontward) in a white display of the liquid crystal display device of the present invention.

FIG. 5

FIG. 5 is a view illustrating a relation between a phase difference of a liquid crystal layer and a black chromaticity (u′ and v′ chromaticities) evaluated in predetermined azimuth angles and polar angles of the liquid crystal display device of the present invention: (a) illustrates variation in the u′ chromaticity; and (b) illustrates variation in the v′ chromaticity.

FIG. 6

FIG. 6 is an explanatory view illustrating an arrangement relation between an absorption axis of a polarizing plate and an in-plane slow axis of a biaxial phase plate in a case where the absorption axis is in parallel with the in-plane slow axis: (a) illustrates an apparent arrangement relation when viewed in an frontward direction; and (b) illustrates an apparent arrangement relation when viewed in an oblique direction.

FIG. 7

FIG. 7 is an explanatory view illustrating an arrangement relation between an absorption axis of a polarizing plate and an in-plane slow axis of a biaxial phase plate in a case where the absorption axis is set to be at right angles to the in-plane slow axis: (a) illustrates an apparent arrangement relation when viewed in an frontward direction; and (b) illustrates an apparent arrangement relation when viewed in an oblique direction.

FIG. 8

FIG. 8 is a perspective view schematically illustrating a configuration of an example of the liquid crystal display device of the present invention.

FIG. 9

FIG. 9 is a perspective view illustrating a configuration of a conventional TN display liquid crystal display device shown as a comparative example: (a) illustrates a configuration of Comparative Example 1; and (b) illustrates a configuration of Comparative Example 2.

FIG. 10

FIG. 10 is a graph illustrating a viewing angle-contrast ratio characteristic as to each of the configuration examples show in (a) through (c) of FIG. 1, (a) through (c) of FIG. 2, and comparative examples shown in (a) and (b) of FIG. 9 and FIG. 17.

FIG. 11

FIG. 11 is a graph illustrating an azimuthal dependency and a polar angle dependency of a relative transmittance characteristic for each tone, as to the configuration examples shown in (a) through (c) of FIG. 1.

FIG. 12

FIG. 12 is a graph illustrating an azimuthal dependency and a polar angle dependency of a relative transmittance characteristic for each tone, as to the configuration examples shown in (a) through (c) of FIG. 2.

FIG. 13

FIG. 13 is a graph illustrating an azimuthal dependency and a polar angle dependency of a relative transmittance characteristic for each tone, as to the comparative examples shown in (a) and (b) of FIG. 9 and FIG. 17.

FIG. 14

FIG. 14 is a graph illustrating a characteristic of a black chromaticity and a difference (distance between colors) from a frontward characteristic of a black chromaticity of each of the configuration examples shown in (a) through (c) of FIG. 1 and the comparative examples shown in (a) and (b) of FIG. 9 and FIG. 17.

FIG. 15

FIG. 15 is a graph illustrating a characteristic of a black chromaticity and a difference (distance between colors) from a frontward characteristic of a black chromaticity of each of the configuration examples shown in (a) through (c) of FIG. 2.

FIG. 16

FIG. 16 is a graph illustrating a polar angle dependency of a relative transmittance characteristic in a case where an in-plane phase difference and a normal phase difference of the biaxial phase plate are changed.

FIG. 17

FIG. 17 is a perspective view schematically illustrating a configuration of a conventional liquid crystal display device of Comparative Example 3.

FIG. 18

FIG. 18 is an explanatory view illustrating a display principle of a conventional TN display mode: (a) illustrates a state during which no voltage is applied; and (b) illustrates a state during which a voltage is being applied.

FIG. 19

FIG. 19 is an explanatory view regarding a refractive index of a multiaxial stretching phase plate: (a) illustrates classifications of multiaxial stretching phase plates; and (b) schematically illustrates an ellipsoidal body of refractive indexes of a negative biaxial phase plate.

FIG. 20

FIG. 20 is a schematic view illustrating part of a clipping process during producing of polarizing plates.

### DESCRIPTION OF EMBODIMENTS

The following describes an embodiment of the present invention with reference to drawings. Note that, for convenience of explanations, etc., such drawings simply show only main members, which are necessary for describing the present invention, among constituents of the embodiment of the present invention.

(Feature of Biaxial Phase Plate)

The “biaxial phase plate” as described herein stands for a film to which optical anisotropy is given by stretching, for example, a polymer film so that a polymer chain orients in the film plane. Specifically, the “biaxial phase plate” represents an optical member in which all main refractive indexes are substantially different from each other, in a case where (i) the phase plate has a thickness of d (nm), (ii) main axes of refractive index ellipsoidal body are x and y axes which are perpendicular to each other and extend in a in-plane direction and z axis which extends in a thickness direction, and (iii) main refractive indexes for the respective main axes are defined as nx, ny, and nz.

According to the present invention, it is preferable to use a member which is prepared based on a basic design which is similar to that for preparing a member such as a biaxial phase plate which is widely employed, in a device such as a VA display liquid crystal display device, so as to compensate a residual phase difference of liquid crystal molecules on a boundary surface of a substrate. This makes it possible to improve display qualities such as a color change occurred when viewed in an oblique direction and a symmetric property of viewing angle characteristics in a TN display liquid crystal display device. Further, identical members can be used in both the VA display liquid crystal display device and the TN display liquid crystal display device. This allows an improvement in use efficiency of members, and therefore allows a notable improvement in cost reduction of the members.

In general, the VA display liquid crystal display device employs a technique for optical compensation especially in a black display state so as to further improve a contrast ratio and a viewing angle characteristic. Such a technique mainly aims to improve the following two problems: (1) a reduction occurs in contrast ratio because a vertical alignment liquid crystal cell itself has a birefringence; and (2) a deterioration occurs in viewing angle characteristic because of a phenomenon in which emitted light leaks in an oblique direction between a pair of upper and lower polarizing plates having respective absorption axes which are arranged perpendicular to each other.

Regarding the problem (1), it is possible to carry out an optical compensation with respect to a liquid crystal layer in which bar-like liquid crystal molecules are oriented, in a black display state, substantially perpendicular to upper and lower substrates, by employing a so-called negative C plate in which the main refractive indexes nx, ny, and nz of the refractive index ellipsoidal body meet nx≈ny>nz.

On the other hand, regarding the problem (2), it is possible to improve a viewing angle characteristic of the liquid crystal panel with the use of two polarizing plates (i) on each of which a so-called A plate (nx>ny≈nz), which has an in-plane slow axis extending in a direction in which a film is stretched, is stacked and (ii) which have respective absorption axes which are arranged perpendicular to each other.

The phase plate on which uniaxial phase plates such as the negative C plate and the A plate are combined and stacked has an extreme beneficial effect on optically compensating and improving the viewing angle characteristic of the VA display liquid crystal display device.

However, in the case where the uniaxial phase plates are used, it is necessary to address the following two problems. One of them is that, in order to efficiently produce a polarizing plate showing a desired optical property, an in-plane slow axis (a direction in which the phase plate is stretched) of the A plate needs to be arranged perpendicular to a direction in which a film roll is unrolled during producing of the polarizing plate. This causes a reduction in productivity of the film. The other is that an inadequate display of the liquid crystal panel and other defect can become obvious due to heat variation of the polarizing plate with a phase plate which heat variation is caused by the fact that uniaxial phase plates having respective different optical properties are stacked.

Against the background described above, owing to innovation and development of a production technique such as a biaxial stretching of a polymer film, a biaxial phase plate (nx>ny>nz), which has properties of the negative C plate and the A plate, has been stably and widely used.

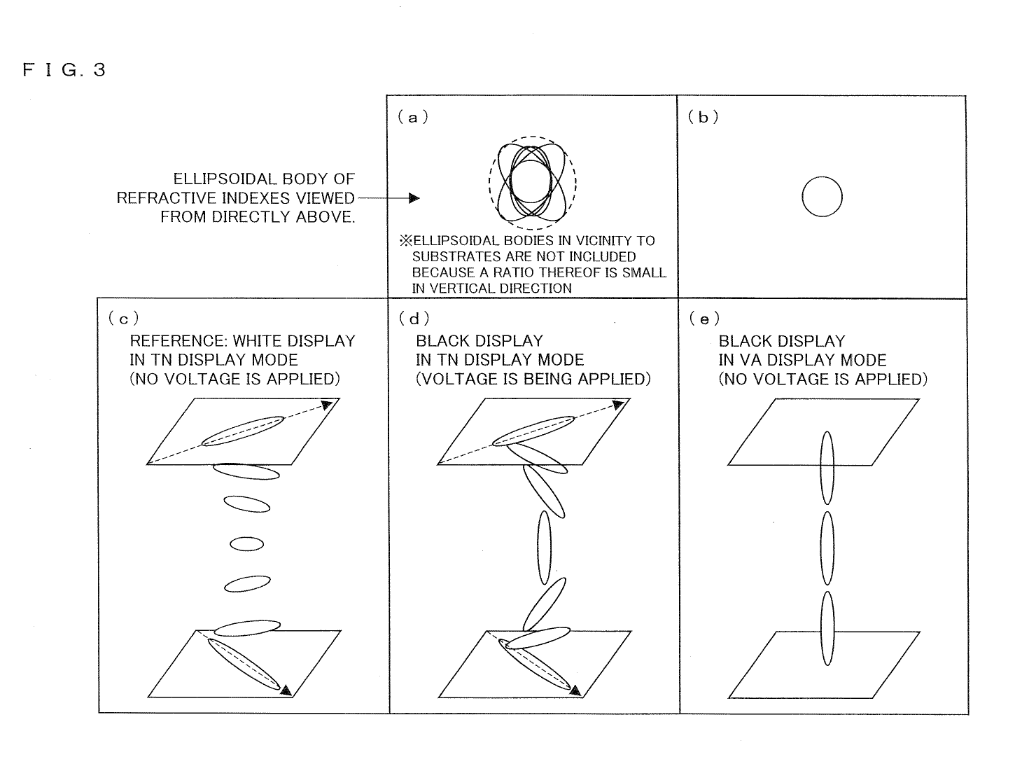

FIG. 3 is a principle view showing how an optical characteristic is improved in a case of using a polarizing plate with a biaxial phase plate of the present invention. According to a general TN display liquid crystal display device, liquid crystal molecules in the center of the liquid crystal layer are oriented substantially vertical to the substrates while a black display is being carried out by applying a voltage (see (d) of FIG. 3). This causes a loss of an optical rotation property occurred during a white display shown in (c) of FIG. 3. The liquid crystal molecules are oriented during a black display in the TN display liquid crystal display device. This is similar to the black display during which no voltage is applied in a VA display mode shown in (e) of FIG. 3.

As is clear from a comparison between (a) and (b) of FIG. 3, transition of orientations of liquid crystal molecules which are in the black display in the TN display mode causes a similarity to a shape of the refractive index ellipsoidal body in a black display in the VA display mode, when viewed from directly above. For the purpose of addressing the problems of the viewing angle characteristic, in principle, it is possible to employ, even in the TN display liquid crystal display device, the biaxial phase plate which has been widely introduced in the VA display liquid crystal display device because of the design for compensating a residual phase difference of liquid crystal molecules on a boundary surface of the substrate.

According to the polarizing plate with a biaxial phase plate of the present invention, an angle at which the in-plane slow axis of the biaxial phase plate is with respect to the absorption axis of the polarizing plate is set to approximately 90 degrees. This allows design for reducing leakage of light in an oblique direction while the liquid crystal panel is carrying out a black display.

In a case where a polarizing plate, which has a common specification to the polarizing plate with the biaxial phase plate for use in the VA display mode, is applied to a TN display liquid crystal display device, a contrast ratio obtained when the liquid crystal panel is viewed in an oblique direction can be drastically improved by setting, to approximately 90 degrees, an angle at which the in-plane slow axis of the biaxial phase plate is with respect to the absorption axis of the polarizing plate.

Moreover, it is possible to clip out polarizing plates with respective biaxial phase plates prepared based on an identical design so that each of the polarizing plates has a shape identical to that of the liquid crystal panel, in a case where the biaxial phase plates are provided on outer surfaces of respective of the upper and lower substrates in the present invention so that their in-plane slow axes are substantially perpendicular to each other.

According to the present invention, a pair of polarizing plates with respective biaxial phase plates can be obtained from a single polarizing plate roll. This makes it possible to reduce unused material generated during producing of the polarizing plate, and therefore area use efficiency of the polarizing plate roll can be drastically improved. As a result, costs of materials can be further reduced.

(Liquid Crystal Display Device of Present Invention Having Biaxial Phase Plates on Outer Sides of Respective of Upper and Lower Substrates)

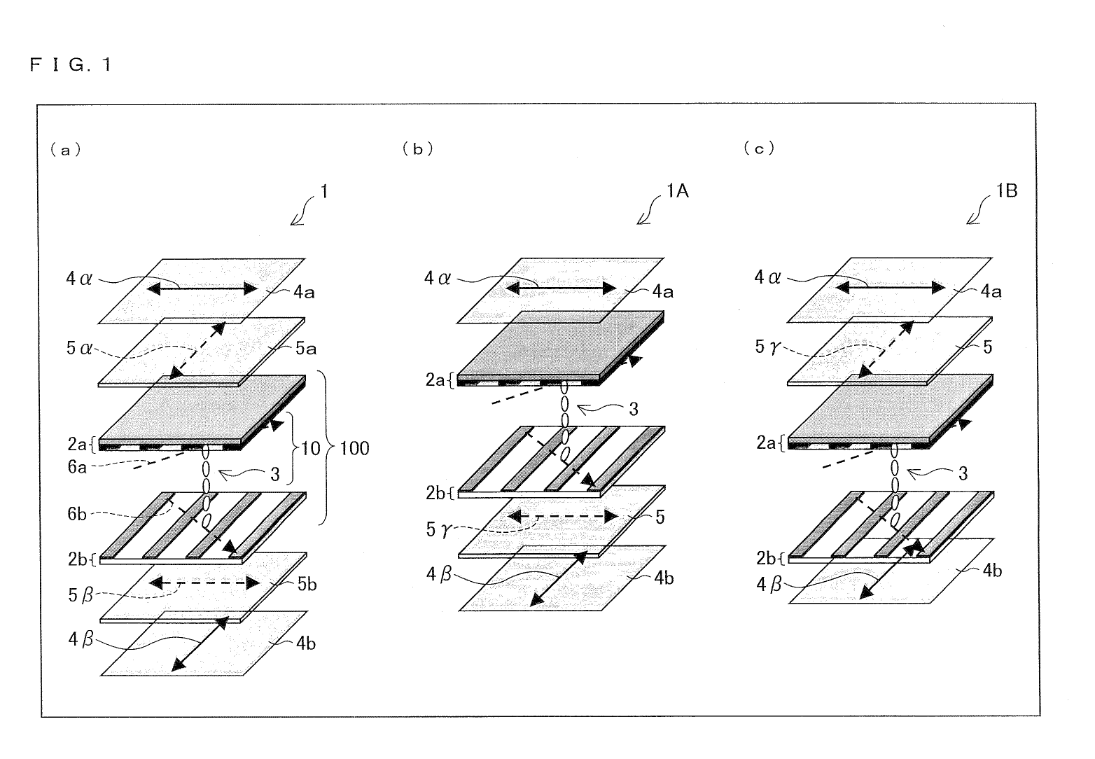

(a) of FIG. 1 illustrates, as a concrete configuration of the present invention, a liquid crystal display device 1 which includes upper and lower biaxial phase plates.

The liquid crystal display device 1 of the present invention includes polarizing plates with respective phase plates provided so that the biaxial phase plates and the respective polarizing plates are adjacent to each other, as described above. According to the polarizing plates, the in-plane slow axis 5α of the biaxial phase plate 5a is arranged so as to be at an angle of approximately 90 degrees to the absorption axis 4α of the polarizing plate 4a, and the in-plane slow axis 5β of the biaxial phase plate 5b is arranged so as to be at an angle of approximately 90 degrees to the absorption axis 4β of the polarizing plate 4b. Note that the in-plane slow axes 5α and 5β are indicated by dotted 2-way arrows, and the absorption axes 4α and 4β are indicated by solid 2-way arrows.

Moreover, the polarizing plate 4a and the biaxial phase plate 5a are provided on an upper side (outer side) of the liquid crystal panel 100 which includes the first substrate 2a and the second substrate 2b between which the liquid crystal layer 10 having the TN display liquid crystal molecules 3 is provided. The polarizing plate 4b and the biaxial phase plate 5b are provided on a lower side (outer side) of the liquid crystal panel 100. The in-plane slow axes 5α and 5β of the upper and lower biaxial phase plates 5a and 5b are set to be arranged substantially perpendicular to each other.

Note that a color filter (CF), a black matrix (BM), and a common electrode are provided on the first substrate 2a, and the first substrate 2a is also called a CF substrate. In the second substrate 2b, components such as a pixel electrode and a TFT (Thin Film Transistor) serving as a switching element are provided for every plurality of pixels, and the second substrate 2b is also called a TFT substrate.

A rubbing direction 6a (indicated by dotted one-way arrow) of the first substrate 2a is set to be at an angle of approximately 45 degrees with the absorption axis 4α of the polarizing plate 4a for the first substrate 2a. Further, a rubbing direction 6b (indicated by dotted one-way arrow) of the second substrate 2b is set to be at an angle of approximately 45 degrees with the absorption axis 4β of the polarizing plate 4b for the second substrate 2b. This is how the liquid crystal display device 1 is configured.

It is preferable, in particular for the TN display liquid crystal display device, that the directions of the absorption axes 4α and 4β of the respective polarizing plates 4a and 4b, which are to be attached to upper and lower sides of the liquid crystal panel 100, are set to be at an angle of approximately 45 degrees to the rubbing directions 6a and 6b, respectively.

This is because, the TN display liquid crystal display device of the present invention is designed so that (1) a twelve o'clock viewing angle (a wide viewing angle direction is an upward direction with respect to a front face of the liquid crystal panel) is employed, (2) the rubbing directions of the upper (viewer side) substrate and the lower substrate are +45 degrees direction and +135 degrees direction, respectively, where a counterclockwise direction is a forward direction in a rotating coordinate system in which a direction pointing the right (so-called three o'clock direction) of the screen of the liquid crystal panel is 0 degree, and (3) the absorption axes of the respective polarizing plate films are set to 0 degree and 90 degrees.

According to the design, it is not necessary to clip out the upper and lower polarizing plates with the respective biaxial phase plates after rotating the polarizing plate roll in the +45 degrees direction and +135 degrees direction with respect to the direction in which the polarizing plate roll is stretched. This causes a contribution to achieve increased effectiveness of suppressing a decrease of the contrast ratio caused when the axes of the respective upper and lower polarizing plates are out of alignment.

The present invention can thus employ a pair of the polarizing plates with respective biaxial phase plates clipped out from a single polarizing plate roll. This also makes it possible to reduce unused material generated during producing of the polarizing plate, and accordingly area use efficiency of the polarizing plate roll can be improved drastically. As a result, the effect of reduction in costs of materials is a further advantage to the present invention.

Moreover, it is preferable that the biaxial phase plate of the present invention has (i) an in-plane phase difference R₀ which falls within a range between 45 nm and 65 nm, the in-plane phase difference R₀ being defined by Formula 1 below and (ii) a normal phase difference Rₜₕ in a thickness direction which normal phase difference Rₜₕ falls within a range between 115 nm and 135 nm, the normal phase difference Rₜₕ being defined by Formula 2 below.

R₀=(nx−ny)·d (Formula 1)

Rₜₕ={(nx+ny)/2−nz}·d (Formula 2)

where x and y are in-plane directions of the biaxial phase plate which are perpendicular to each other; z is a thickness direction of the biaxial phase plate; nx, ny, and nz are main refractive indexes, at 25° C., for the respective directions x, y, and z; and d (nm) is a thickness of the biaxial phase plate.

This is because a gradation reversal phenomenon in halftone remarkably tends to occur unless the in-plane phase difference R₀ and the normal phase difference Rₜₕ fall within the above respective ranges. In particular, in a case where the phase differences R₀ and Rₜₕ do not fall within respective set ranges, leakage of light tends to become large in quantity during displaying of a black tone. This causes a gradation reversal to occur in a narrower range of viewing angles.

This is based on consideration results obtained with the use of an optical simulation, as later discussed in Example 2.

According to the liquid crystal display device of the present invention, it is preferable that the liquid crystal layer has a phase difference which falls within a range between 400 nm and 470 nm, on condition of a temperature of 25° C. and a wavelength of 550 nm. This can be explained in consideration of properties such as relative transmittance, color reproductivity, and a tinge.

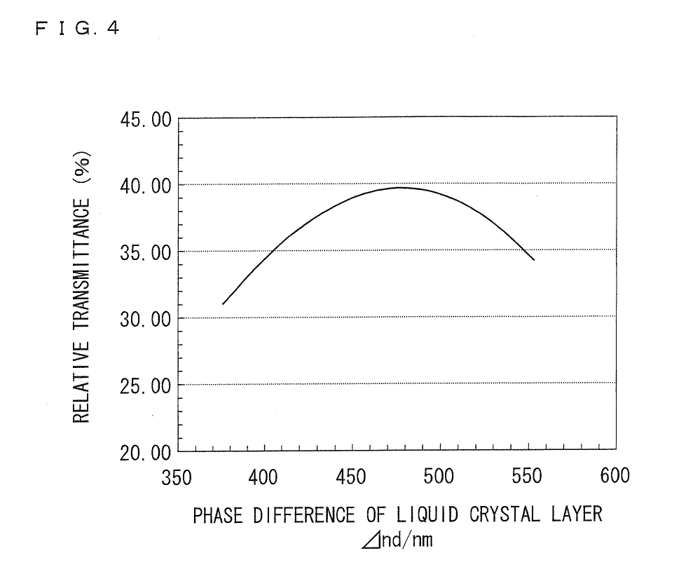

That is, it is preferable that the liquid crystal layer has a phase difference which falls within a range between 400 nm and 540 nm, in terms of relative transmittance of a front face of the liquid crystal panel which is in a state of white display (see FIG. 4). It is more preferable that the phase difference falls within a range between 425 nm and 530 nm in which range the relative transmittance falls within 10% of the maximum relative transmittance.

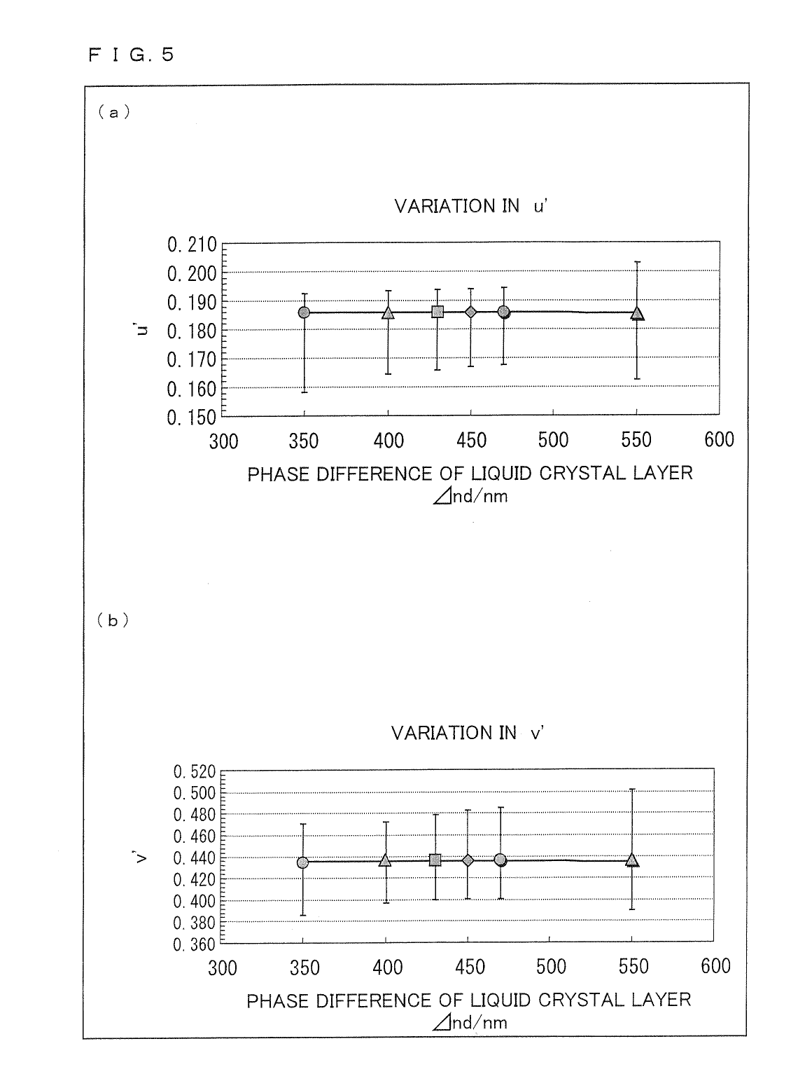

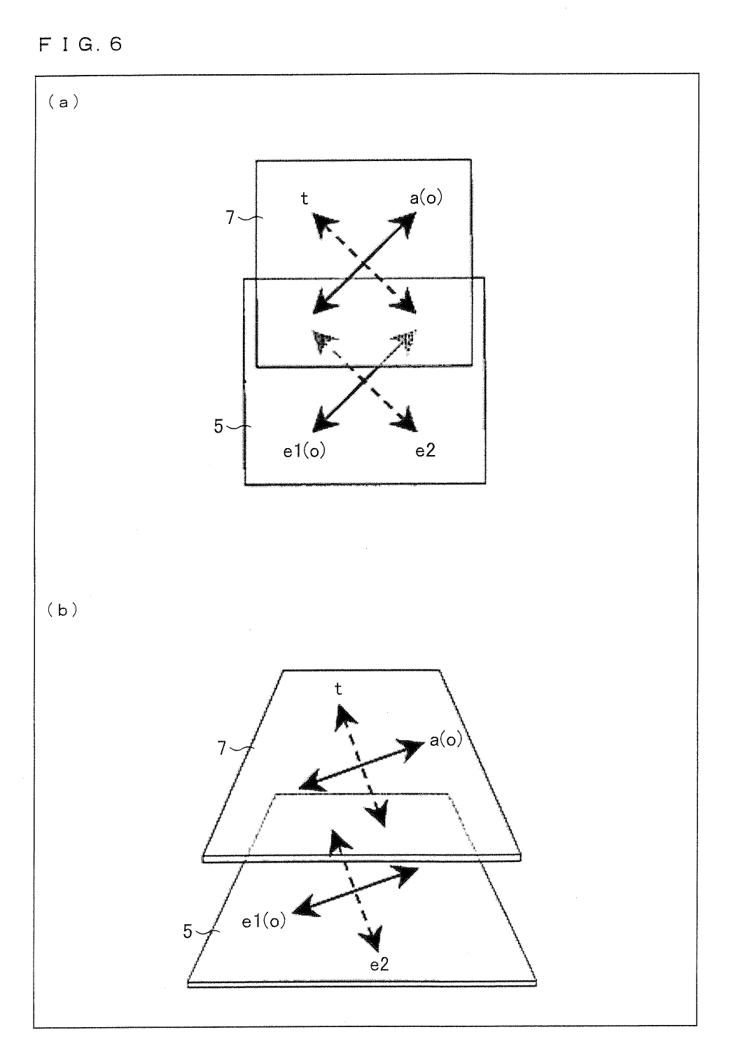

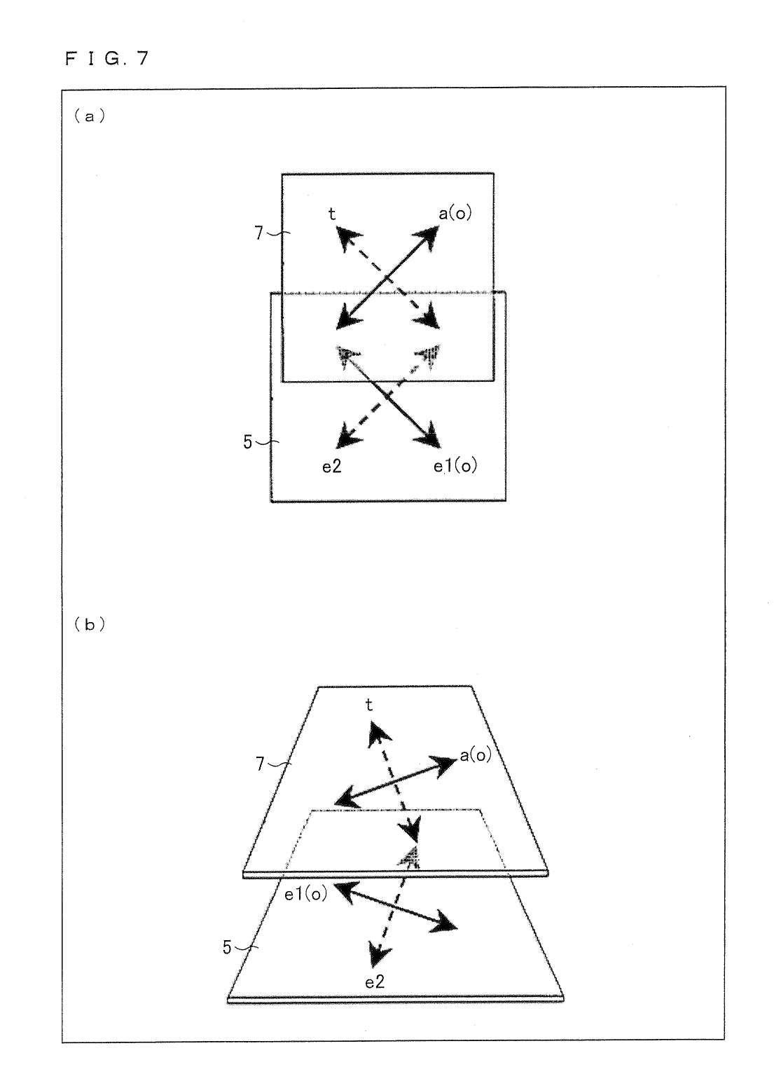

When a phase difference is more than 470 nm, (i) a white display tends to become yellowish even in an area in which the transmittance is high, in terms of a tinge of the liquid crystal panel and (ii) a variation in black chromaticity (variations in a u′-chromaticity and a v′-chromaticity) tends to become large (see (a) and (b) of FIG. 5), in terms of the variation in black chromaticity. This causes a tendency for the display quality to be deteriorated. Note that points plotted in each of the variation ranges indicate black chromaticity of the front face (a direction corresponding to an azimuth angle of 0 degree and a direction corresponding to a polar angle of 0 degree).

Moreover, a range of the variation in the black chromaticity tends to become large even in an area where a phase difference of the liquid crystal layer is 350 nm, which is smaller than 400 nm (see (a) of FIG. 5).

The “variation in black chromaticity” is, as later described, a result obtained when carrying out an evaluation, by changing a phase difference of the liquid crystal layer, with respect to a range of the variation in black chromaticity which occurs when sequentially scanning the liquid crystal panel while changing an azimuth angle and a polar angle.

In view of comprehensive consideration of the viewpoints, it is preferable that an optimal phase difference range of the liquid crystal layer falls within the range between 400 nm and 470 nm.

(Liquid Crystal Display Device Having a Biaxial Phase Plate on Outer Side of One of Upper and Lower Substrates)

The following description discusses another concrete example of the present invention in which each of liquid crystal display devices 1A and 1B has a single biaxial phase plate 5 provided only on one of upper and lower substrates 2a and 2b, with reference to (b) and (c) of FIG. 1.

The liquid crystal display device 1A of the present invention includes a polarizing plate with a phase plate in which a biaxial phase plate 5 and a polarizing plate 4 are provided adjacent to each other (see (b) of FIG. 1). According to the polarizing plate with the phase plate, an in-plane slow axis 5γ (indicated by a dotted 2-way arrow) of the biaxial phase plate 5 is at an angle of approximately 90 degrees to an absorption axis 4β (indicated by a solid 2-way arrow) of a lower polarizing plate 4b (see (b) of FIG. 1), as with the configuration describe above. The polarizing plate with the phase plate is provided on a lower side (outer side) of the second substrate 2b.

Moreover, a polarizing plate 4a is provided on an upper side (outer side) of the first substrate 2a so that a rubbing direction 6a of the first substrate 2a is set to be at an angle of approximately 45 degrees with an absorption axis 4α of the polarizing plate 4a corresponding to the first substrate 2a. Further, a rubbing direction 6b of the second substrate 2b is set to be at an angle of approximately 45 degrees with the absorption axis 4β of the polarizing plate 4b corresponding to the second substrate 2b.

On the other hand, according to the liquid crystal display device 1B of the present invention, a polarizing plate with a phase plate including the upper polarizing plate 4a and the biaxial phase plate 5 is provided on an upper side (outer side) of the first substrate 2a so that an in-plane slow axis 5γ (indicated by a dotted 2-way arrow) of the biaxial phase plate 5 is at an angle of approximately 90 degrees to the absorption axis 4α (indicated by a solid 2-way arrow) of the upper polarizing plate 4a (see (c) of FIG. 1). Further, the polarizing plate 4b is provided on a lower side (outer side) of the second substrate 2b.

Note that the rubbing directions 6a and 6b are set to be at an angle of approximately 45 degrees to the respective absorption axes 4α and 4β, as with the configuration of the liquid crystal display device 1A.

The phase difference of the biaxial phase plate and the optimal phase difference range of the liquid crystal layer are also applicable to the present embodiment, for the reason similar to the case where the polarizing plates with respective biaxial phase plates are provided on respective of the upper and lower substrates.

According to the present embodiment, it is sometimes effective when, in particular, the biaxial phase plate 5 is provided only on an outer side of the second substrate 2b. Note that the viewer is on the upper side and the second substrate 2b is on the lower side, i.e., on a side opposite to the upper side on which the viewer is. This is because of the following first and second reasons.

The first reason is that a symmetric property of right and left viewing angles can be more improved than the case where the biaxial phase plate 5 is provided only on the upper substrate. The second reason is that, in a case where another new polarizing plate with a phase plate is attached again via a reworking step so as to address a trouble occurred during manufacturing of the liquid crystal panel, it is necessary to replace a stacked polarizing plate (the polarizing plate with the phase plate on which an antireflection layer is provided) which is prepared through the larger number of steps because a front surface of the polarizing plate, which is provided on the upper side (on the viewer side) of the liquid crystal panel, is often subjected to an antireflection layer forming step. This causes a drastic disadvantage in view of cost.

For the first and second reasons, it is effective more in the case where the biaxial phase plate 5 is provided only on the lower substrate 2b than in the case where the biaxial phase plate 5 is provided only on the upper substrate 2a.

The following describes further detailed explanations with reference to concrete examples, etc. Note, however, that the present invention is not limited to such concrete examples.

### Example 1

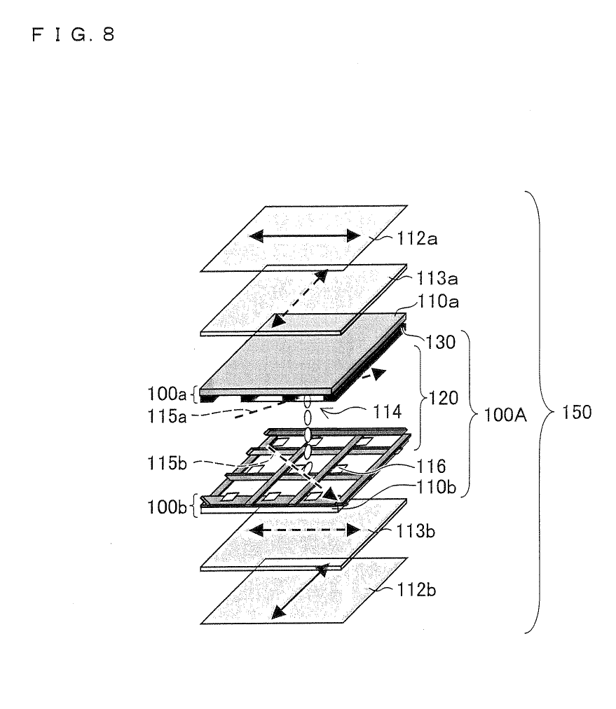

The following description discusses an embodiment of the present invention with reference to FIG. 8.

A liquid crystal display (LCD) panel 100A includes a first substrate (CF substrate) 100a and a second substrate (TFT substrate) 100b between which a liquid crystal layer 120 is provided. The first substrate 100a includes a transparent substrate (e.g., glass substrate) 110a, and the second substrate 100b includes a transparent substrate 110b. The liquid crystal layer 120 is provided between the transparent substrate 110a and the transparent substrate 110b which are provided so as to face each other. First and second liquid crystal alignment layers (not illustrated) are deposited on a first surface of the transparent substrate 110a and a second surface of the transparent substrate 110b, respectively. The first and second surfaces are contact with the liquid crystal layer 120. The first and second liquid crystal alignment layers have respective surfaces which face each other and are subjected to alignment controls in predetermined rubbing directions 115a and 115b (in directions indicated by respective dotted arrows), respectively, with the use of a know method.

While no voltage is applied (while a voltage lower than a threshold voltage is being applied), liquid crystal molecules 114 in the liquid crystal layer 120 are uniformly oriented substantially in parallel with the surfaces of the liquid crystal alignment films while having a predetermined pretilt angle. Note that, in a case of a normally white (NW) display mode, the liquid crystal layer 120 contains a nematic liquid crystal material having a positive dielectric anisotropy, and further contains a chiral agent if necessary.

The second substrate 100b includes (i) an active matrix component such as a TFT element 116 which is provided on the transparent substrate 110b, (ii) circuit components (not illustrated) such as a gate line and a source line which are connected to the TFT element 116, and (iii) a pixel electrode which is connected to the TFT element 116. A counter electrode is provided on the transparent substrate 110a. With the configuration, a pixel is defined by the liquid crystal layer 120 provided between the pixel electrode and the counter electrode. Note that each of the pixel electrode and the counter electrode is made of a transparent conductive layer (e.g., an ITO layer).

According to a typical configuration, (i) color filters 130 for respective pixel are provided and a black matrix (light shielding layer) is provided between any two adjacent color filters 130, on a side of the transparent substrate 110a which side faces the liquid crystal layer 120 and (ii) the counter electrode is provided on the color filters 130 and the black matrix. The present embodiment is, however, not limited to this. Instead, the color filters 130 and the black matrix can be provided on the counter electrode (the counter electrode is provided on a side of the transparent substrate 110a which side faces the liquid crystal layer 120). The whole of the color filters 130 and the black matrix are referred to as a color filter layer.

The rubbing direction 115a of the transparent substrate 110a and the rubbing direction 115b of the transparent substrate 110b are arranged so as to intersect at a predetermined angle. A nematic liquid crystal material is sealed between the transparent substrates 110a and 110b with the use of members such as a cell thickness controlling member (not illustrated) and a sealing member (not illustrated).

According to the TN display liquid crystal display device 150 of the present invention, a pair of predetermined polarizing plates 112a and 112b are provided on respective upper and lower outer sides of the liquid crystal panel 100A. A pair of biaxial phase plates 113a and 113b are further provided on respective upper and lower outer sides of the liquid crystal panel 100A. The polarizing plates 112a and 112b are arranged so that their absorption axes are perpendicular to each other.

The rubbing directions 115a and 115b, the absorption axes of the respective polarizing plates 112a and 112b, and the in-plane slow axes of the respective biaxial phase plates 113a and 113b are arranged as described earlier.

### Example 2

According to the present example, by changing arrangement relations of the rubbing directions of the substrates, the absorption axes of the polarizing plates, and the in-plane slow axes of the biaxial phase plates, the arrangement relations are compared and evaluated by an optical simulation, in terms of properties such as (i) a contrast ratio, (ii) a viewing angle characteristic, (iii) an azimuth angle dependency and a polar angle dependency of a transmittance characteristic for each tone, and (iv) a variation in black chromaticity.

The variation in the arrangement relations which are subjected to the optical simulation is first described. The following Configuration Examples 1 through 6 are based on the arrangement relations of the present invention, whereas the following Comparative Examples 1 through 3 do not employ the arrangement relations of the present invention.

Note that angles described blow are based on the premise that a counterclockwise direction is a forward direction in a rotating coordinate system in which a direction pointing the right (three o'clock) direction of a screen of the liquid crystal panel 0 degree. Note also that the rubbing directions of the upper and lower substrates are set to be identical in Examples 1 through 6 and Comparative Examples 1 and 2. Specifically, the rubbing direction of the upper substrate is set to +45 degrees, and the rubbing direction of the lower substrate is set to +315 degrees in Examples 1 through 6 and Comparative Examples 1 and 2.

### Configuration Example 1

Arrangement relations of Configuration Example 1 are shown in (a) of FIG. 1. According to Configuration Example 1, the arrangement relations of the absorption axes 4α and 4β, the rubbing directions 6a and 6b, and the in-plane slow axes 5α and 5β are described below in an order of being close to the viewer side:

the absorption axis 4α is arranged in parallel with 0-degree line and +180-degree line;

the in-plane slow axis 5α is arranged in parallel with +90-degree line and +270-degree line;

the rubbing direction 6a is directed toward +45-degree direction;

the rubbing direction 6b is directed toward +315-degree direction;

the in-plane slow axis 5β is arranged in parallel with the 0-degree line and the +180-degrees line;

the absorption axis 4β is arranged in parallel with the +90-degree line and the +270-degree line.

### Configuration Example 2

Arrangement relations of Configuration Example 2 are shown in (b) of FIG. 1. According to Configuration Example 2, the arrangement relations of the absorption axes 4α and 4β, the rubbing directions 6a and 6b, and the in-plane slow axis 5γ are described below in an order of being close to the viewer side:

the absorption axis 4α is arranged in parallel with 0-degree line and +180-degree line;

the rubbing direction 6a is directed toward +45-degree direction;

the rubbing direction 6b is directed toward +315-degree direction;

the in-plane slow axis 5γ is arranged in parallel with the 0-degree line and the +180-degree line;

the absorption axis 4β is arranged in parallel with +90 degree line and +270-degree line.

### Configuration Example 3

Arrangement relations of Configuration Example 3 are shown in (c) of FIG. 1. According to Configuration Example 3, the arrangement relations of the absorption axes 4α and 4β, the rubbing directions 6a and 6b, and the in-plane slow axis 5γ are described below in an order of being close to the viewer side:

the absorption axis 4α is arranged in parallel with 0-degree line and +180-degree line;

the in-plane slow axis 5γ is arranged in parallel with +90 degree line and +270-degree line;

the rubbing direction 6a is directed toward +45-degree direction;

the rubbing direction 6b is directed toward +315-degree direction;

the absorption axis 4β is arranged in parallel with the +90-degree line and the +270-degree line.

### Configuration Example 4

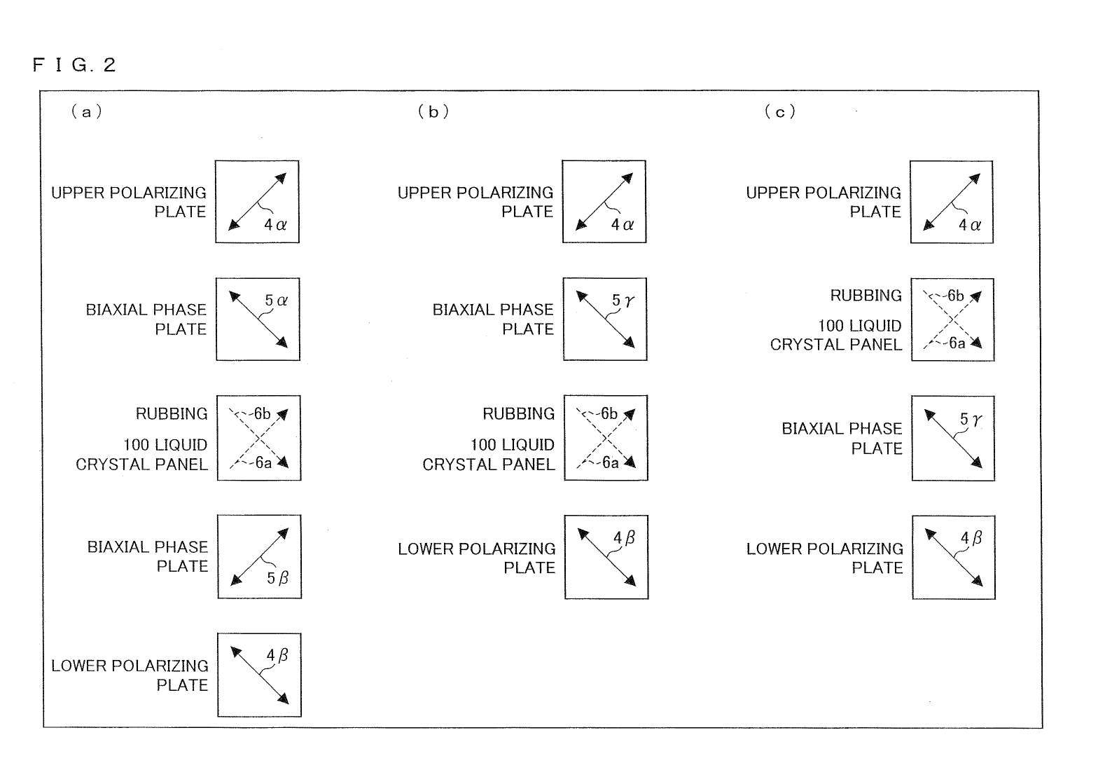

Arrangement relations of Configuration Example 4 are shown in (a) of FIG. 2. According to Configuration Example 4, the arrangement relations of the absorption axes 4α and 4β and the in-plane slow axes 5α and 5β are obtained by rotating at +45 degrees the arrangement relations of the Configuration Example 1. The arrangement relations of Configuration Example 4 are described below in an order of being close to the viewer side:

the absorption axis 4α is arranged in parallel with +45-degree line and +225-degree line;

the in-plane slow axis 5α is arranged in parallel with +135-degree line and +315-degree line;

the rubbing direction 6a is directed toward +45-degree direction;

the rubbing direction 6b is directed toward +315-degree direction;

the in-plane slow axis 5β is arranged in parallel with the +45-degree line and the +225-degree line;

the absorption axis 4β is arranged in parallel with the +135-degree line and the +315-degree line.

### Configuration Example 5

Arrangement relations of Configuration Example 5 are shown in (b) of FIG. 2. According to Configuration Example 5, the arrangement relations of the absorption axes 4α and 4β and the in-plane slow axis 5γ are obtained by rotating at +45 degrees the arrangement relations of the Configuration Example 3. The arrangement relations of Configuration Example 5 are described below in an order of being close to the viewer side:

the absorption axis 4α is arranged in parallel with +45-degree line and +225-degree line;

the in-plane slow axis 5γ is arranged in parallel with +135-degree line and +315-degree line;

the rubbing direction 6a is directed toward +45-degree direction;

the rubbing direction 6b is directed toward +315-degree direction;

the absorption axis 4β is arranged in parallel with the +135-degree line and the +315-degree line.

### Configuration Example 6

Arrangement relations of Configuration Example 6 are shown in (c) of FIG. 2. According to Configuration Example 6, the arrangement relations of the absorption axes 4α and 4β and the in-plane slow axes 5α and 5β are obtained by rotating at +45 degrees the arrangement relations of the Configuration Example 2. The arrangement relations of Configuration Example 6 are described below in an order of being close to the viewer side:

the absorption axis 4α is arranged in parallel with +45-degree line and +225-degree line;

the rubbing direction 6a is directed toward +45-degree direction;

the rubbing direction 6b is directed toward +315-degree direction;

the in-plane slow axis 5γ is arranged in parallel with the +45-degree line and the +225-degree line;

the absorption axis 4β is arranged in parallel with +135-degree line and +315-degree line.

### Comparative Example 1

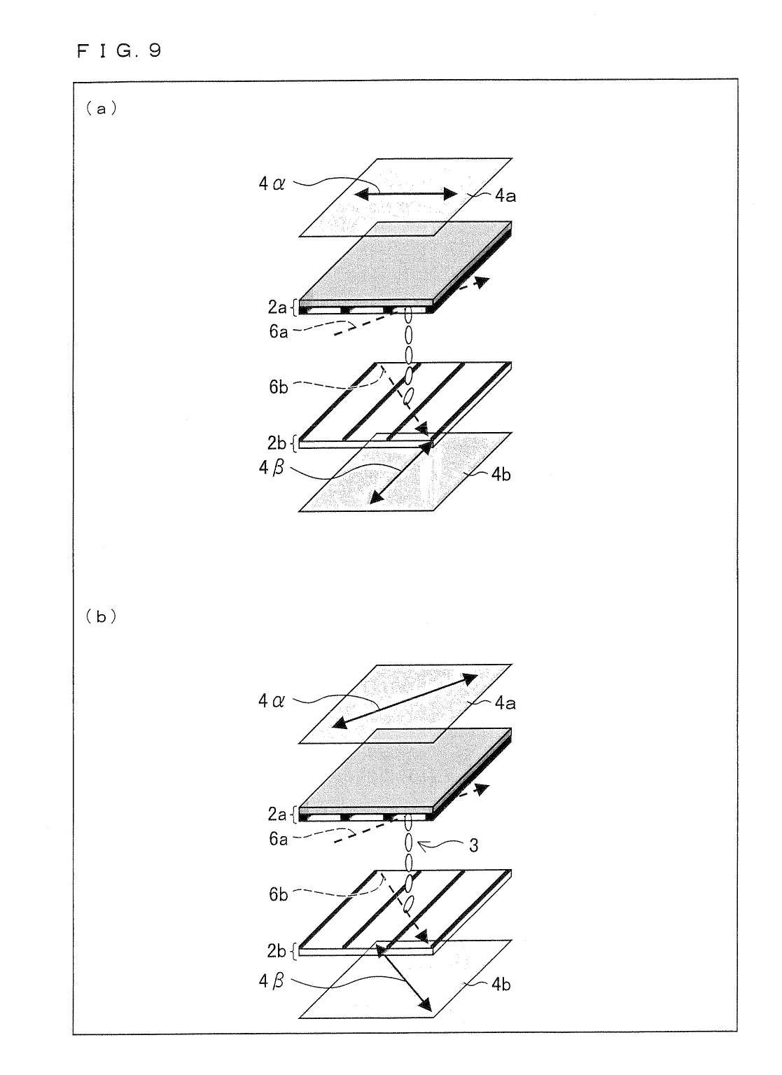

A configuration of Comparative Example 1 is shown in (a) of FIG. 9. Comparative Example 1 relates to a conventional normally white (NW) display liquid crystal display device in which no phase plate is provided. Arrangement relations of absorption axes 4α and 4β and rubbing directions 6a and 6b of Comparative Example 1 are described below in an order of being close to the viewer side:

the absorption axis 4α is arranged in parallel with 0-degree line and +180-degree line;

the rubbing direction 6a is directed toward +45-degree direction;

the rubbing direction 6b is directed toward +315-degree direction;

the absorption axis 4β is arranged in parallel with +90-degree line and +270-degree line.

### Comparative Example 2

A configuration of Comparative Example 2 is shown in (b) of FIG. 9. The configuration of Comparative Example 2 can be obtained by rotating at +45 degrees the polarizing plates 4a and 4b of Comparative Example 1. Arrangement relations of absorption axes 4α and 4β and rubbing directions 6a and 6b of Comparative Example 2 are described below in an order of being close to the viewer side:

the absorption axis 4α is arranged in parallel with +45-degree line and +225-degree line;

the rubbing direction 6a is directed toward +45-degree direction;

the rubbing direction 6b is directed toward +315-degree direction;

the absorption axis 4β is arranged in parallel with +135-degree line and +315-degree line.

### Comparative Example 3

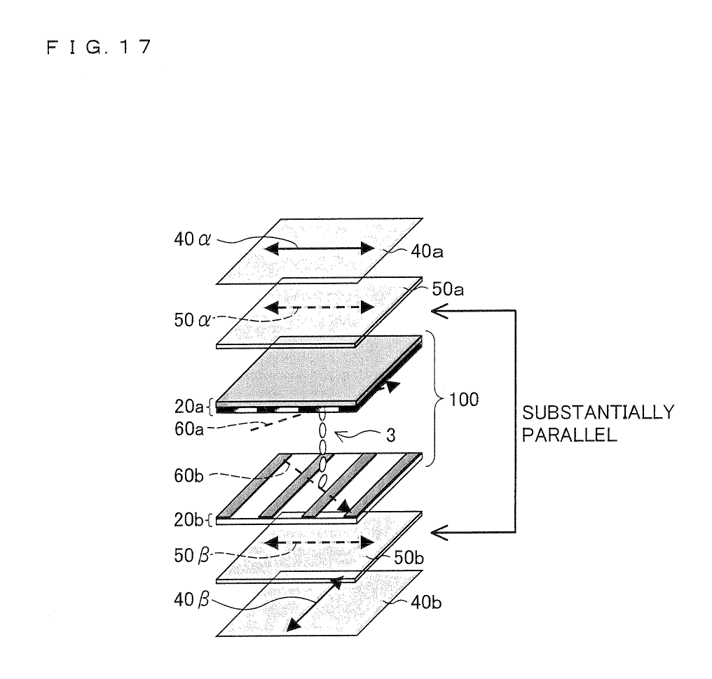

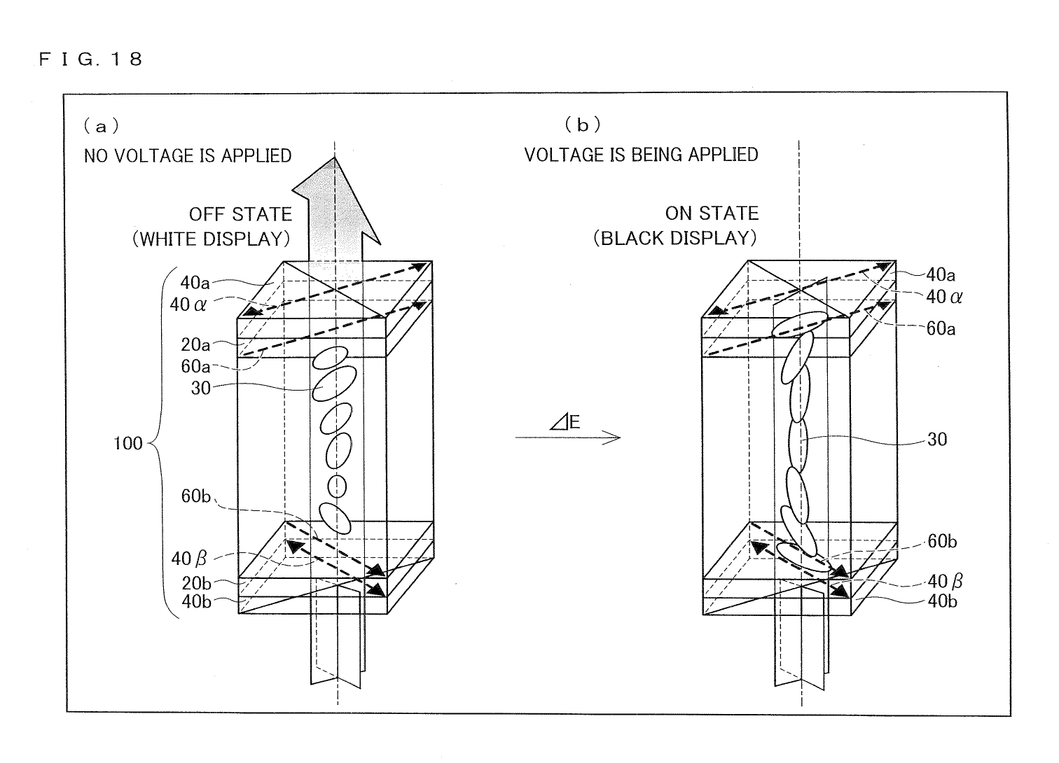

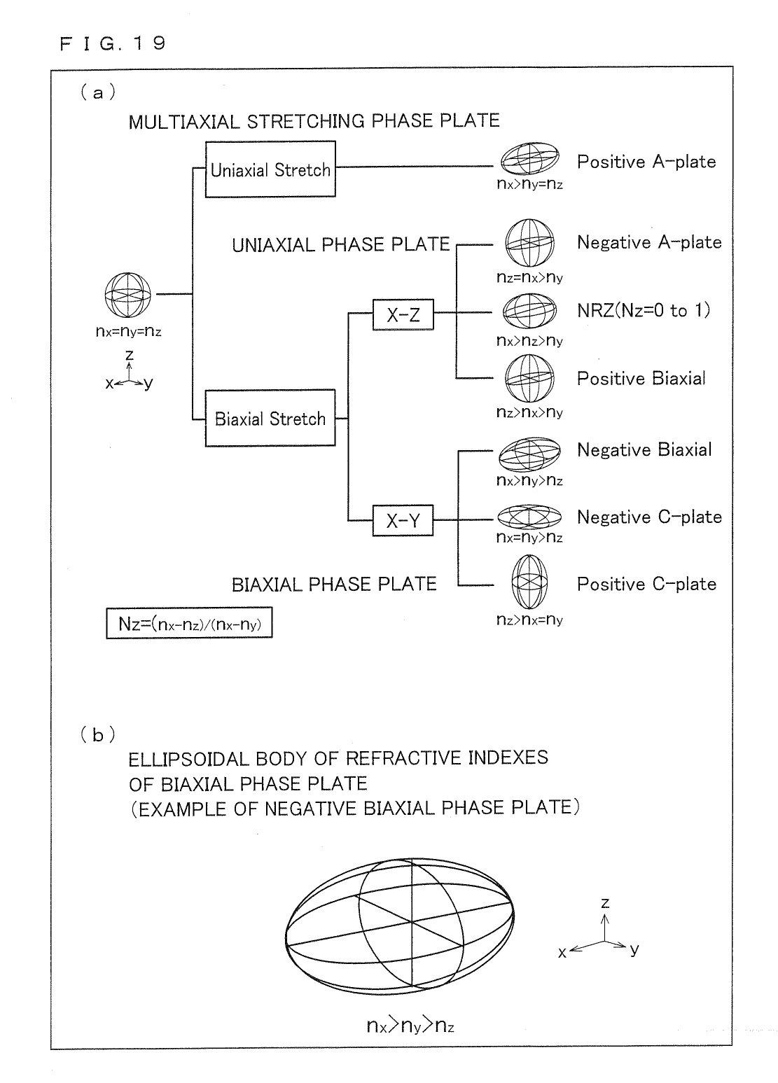

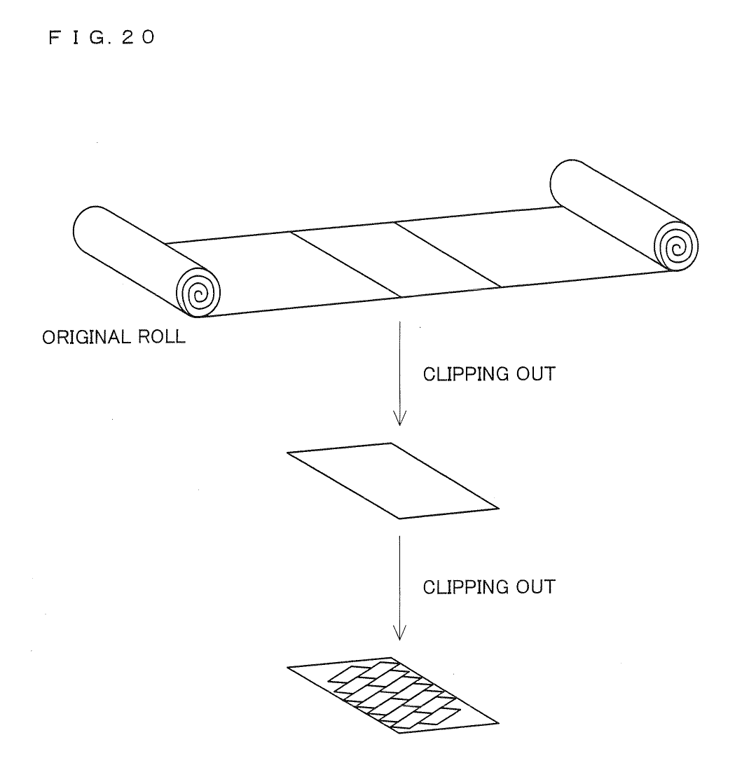

Comparative Example 3 relates to a configuration disclosed in Patent Literature 1 which is shown in FIG. 17. Arrangement relations of absorption axes 40α and 40β, rubbing directions 60a and 60b, and in-plane slow axes 5α and 5β of Comparative Example 3 are described below in an order of being close to the viewer side:

the absorption axis 40α is arranged in parallel with 0-degree line and +180-degree line;

the in-plane slow axis 50α is arranged in parallel with the 0-degree line and the +180-degree line;

the rubbing direction 60a is directed toward +45-degree direction;

the rubbing direction 60b is directed toward +315-degree direction;

the in-plane slow axis 50β is arranged in parallel with the 0-degree line and the +180-degree line;

the absorption axis 40β is arranged in parallel with +90-degree line and +270-degree line.

### Evaluation Results Obtained from Optical Simulations of Respective Examples

Configuration Examples 1 through 6 and Comparative Examples 1 through 3 were compared with each other and evaluated by optical simulations, in terms of properties such as a contrast ratio and a viewing angle characteristic; an azimuth angle dependency and a polar angle dependency of a transmittance characteristic for each tone; and a variation in black chromaticity.

The optical simulations were carried out with the use of a design simulator for liquid crystal display apparatus (product name: LCD Master; manufactured by SHINTECH, INC.). The optical evaluation was carried out with respect to a liquid crystal layer under conditions of: no chiral material; a wavelength of 550 nm; a temperature of 25° C.; an ordinary light refractive index (no) of 1.481637; an extraordinary light refractive index (ne) of 1.580477; an anisotropy (Δn) of a refractive index of 0.09884; a pretilt angle of 3 degrees; and a cell thickness of 4.6 μm.

The optical characteristics were calculated within a wavelength range between 380 nm and 780 nm (which is a visible region) with the use of a standard illumination source D₆₅ as a light source. Further, an optical analysis was carried out based on how molecule directors behaved in a case where, as the optical calculation conditions, a voltage of 0 V is applied to the liquid crystal layer in a white display and a voltage of 5 V is applied to the liquid crystal layer in a black display. The molecule directors are obtained by evenly dividing the liquid crystal layer into 30 layers.

Note that the evaluation was carried out based on results of the optical analysis under conditions that (i) the azimuth angles were set every 15 degrees in a counterclockwise direction starting from a right hand (three o'clock) direction of the screen which direction is regarded as a reference direction of 0 degree and (ii) the polar angles were set every 10 degrees starting from 0 degree which is the vertical point corresponding to a north pole of the earth.

On the occasion of optically calculating (i) the contrast ratio and the viewing angle characteristic and (ii) the azimuth angle dependency and the polar angle dependency of the transmittance characteristic for each tone, a plurality of gradation voltages were successively set from a white display voltage (high tone) to a black display voltage (low tone) so as to evaluate how molecule directors behaved when a halftone voltage was applied to the liquid crystal layer. More specifically, the gradation voltages were set as follows: 0 V for a tone (1); 1.9 V for a tone (2); 2.1 V for a tone (3); 2.3 V for a tone (4); 2.5 V for a tone (5); and 5 V for a tone (6).

The azimuth angle dependency was evaluated as polar angle-relative transmittance characteristics obtained in case of the 0-degree direction, the 45-degree direction, and the 90-degree direction. The relative transmittance as herein described was defined as a relative value on condition that a luminance obtained in a case where a polarizing plate, etc. is not provided, i.e., a luminance in the air is 1.

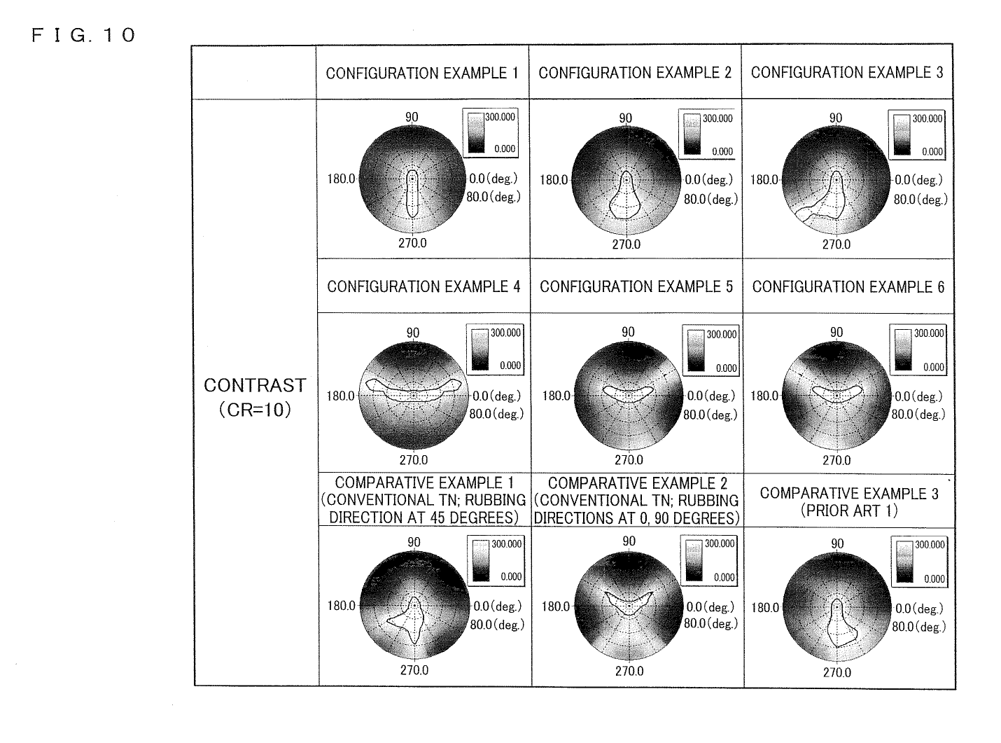

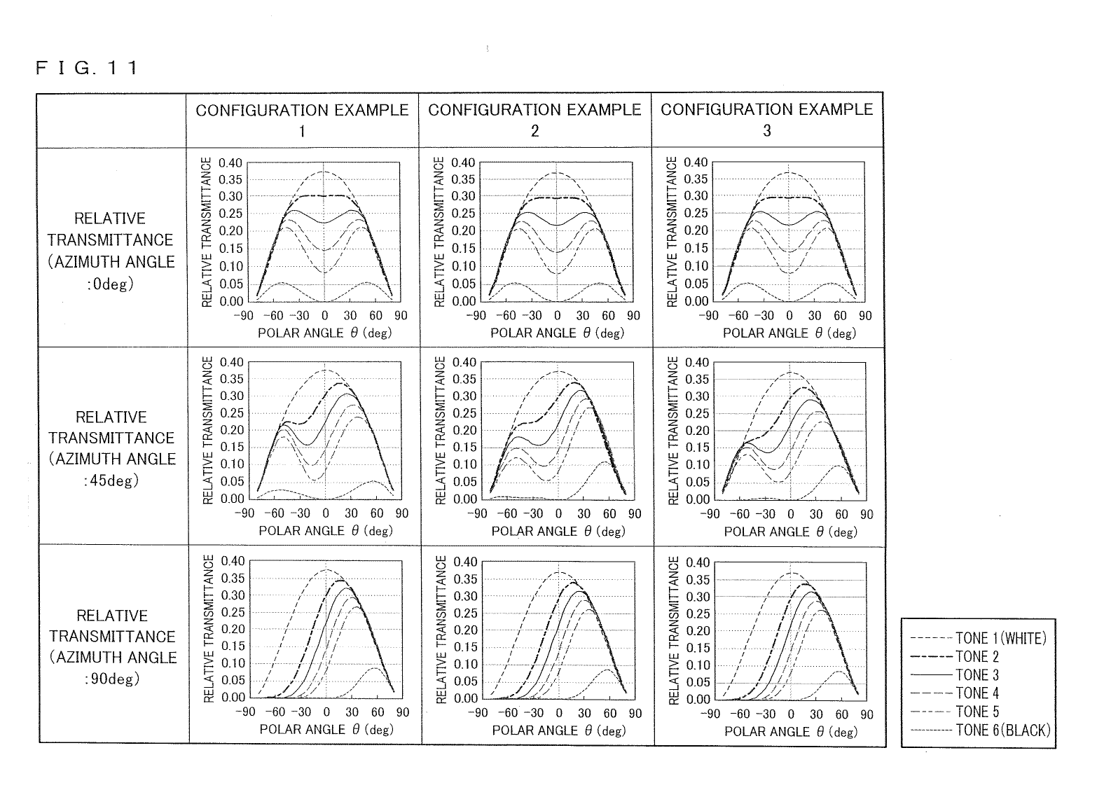

As is illustrated in FIGS. 11 through 13, the azimuth angle dependency and the polar angle dependency of the transmittance characteristic for each tone are shown by curves of polar angle-transmittance characteristics each of which curves shows, in a two-dimensional manner, the azimuth angle dependency and the polar angle dependency when the azimuth angle dependency and the polar angle dependency are cut into round slices in a direction including the predetermined azimuth angle. In this case, the polar angle has a positive value when it is on the right side of 0 degree whereas has a negative value when it is on the left side of 0 degree. Moreover, FIG. 10 illustrates equal-contrast curves (circular graphs) each of which illustrates a contrast ratio and a viewing angle characteristic. In each of the equal-contrast curves, a range in which a contrast ratio of 10 or more is achieved is drawn by a solid line.

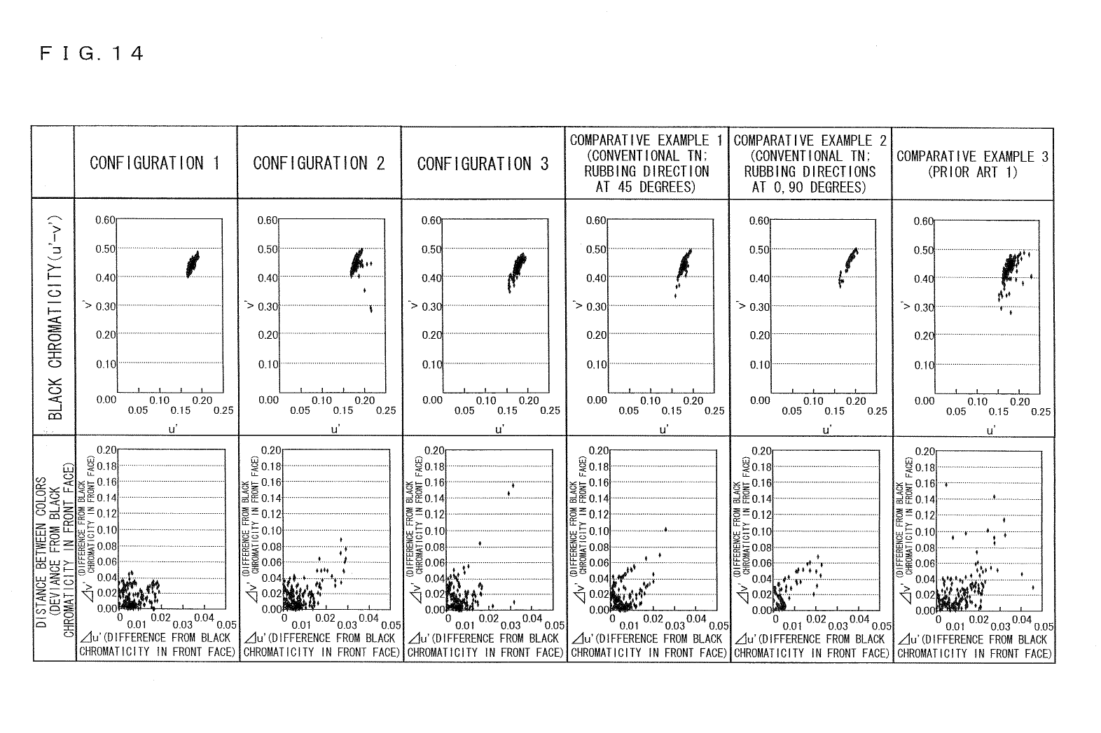

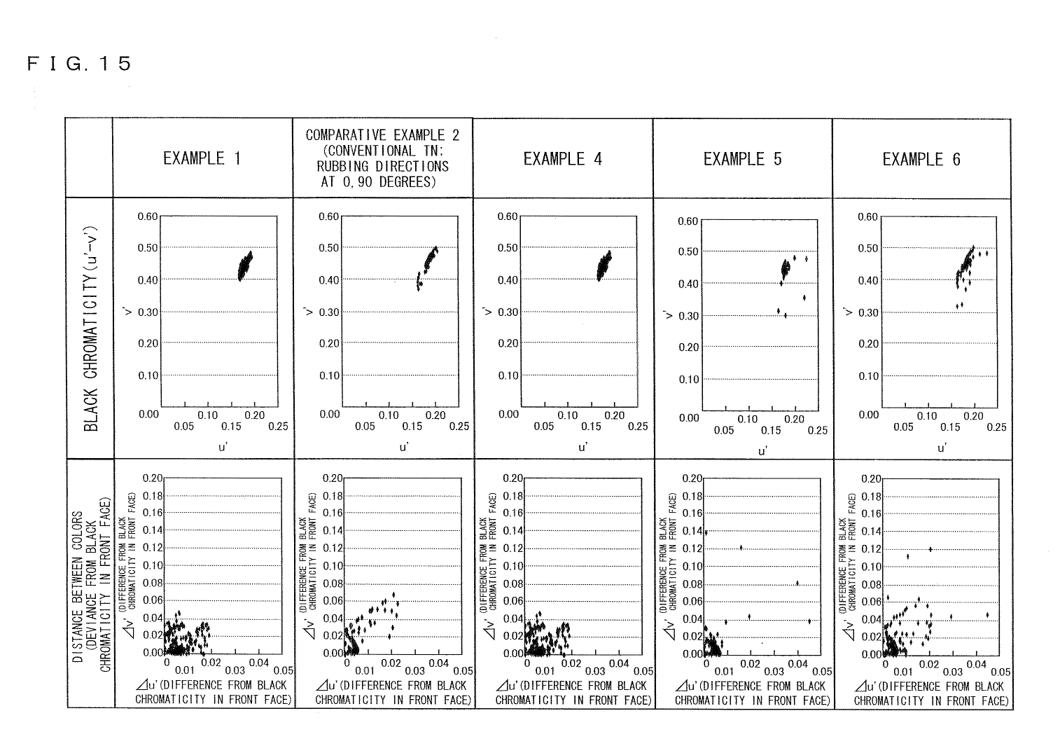

Each of upper graphs of FIGS. 14 and 15 illustrates black chromaticity of a corresponding one of liquid crystal display devices of the Configuration Examples and the Comparative Examples, and each of lower graphs of FIGS. 14 and 15 illustrates deviance of the black chromaticity (distance between colors) from front characteristic of the black chromaticity.

Note that a color characteristic of the liquid crystal display device such as black chromaticity was evaluated with the use of u′ v′ chromaticity coordinate system which is based on a uniform chromaticity diagram (CIE1960USC chromaticity diagram) determined by the International

Commission on Illumination (CIE). FIGS. 14 and 15 are graphs of the examples each of which illustrates a relation of the black chromaticity (u′v′ value) in the center of the display screen when scanning the display screen by use of the simulator, while the azimuth angle and the polar angle, obtained when the black display voltage is applied (tone (6): 5 V), are successively changed in accordance with the above described angle conditions. Further, a color variation in black chromaticity is illustrated as an index of a difference (distance between colors) from the black chromaticity of the front face of the display screen. Note that each of the azimuth angle and the polar angle is 0 degree in the front face of the display screen.

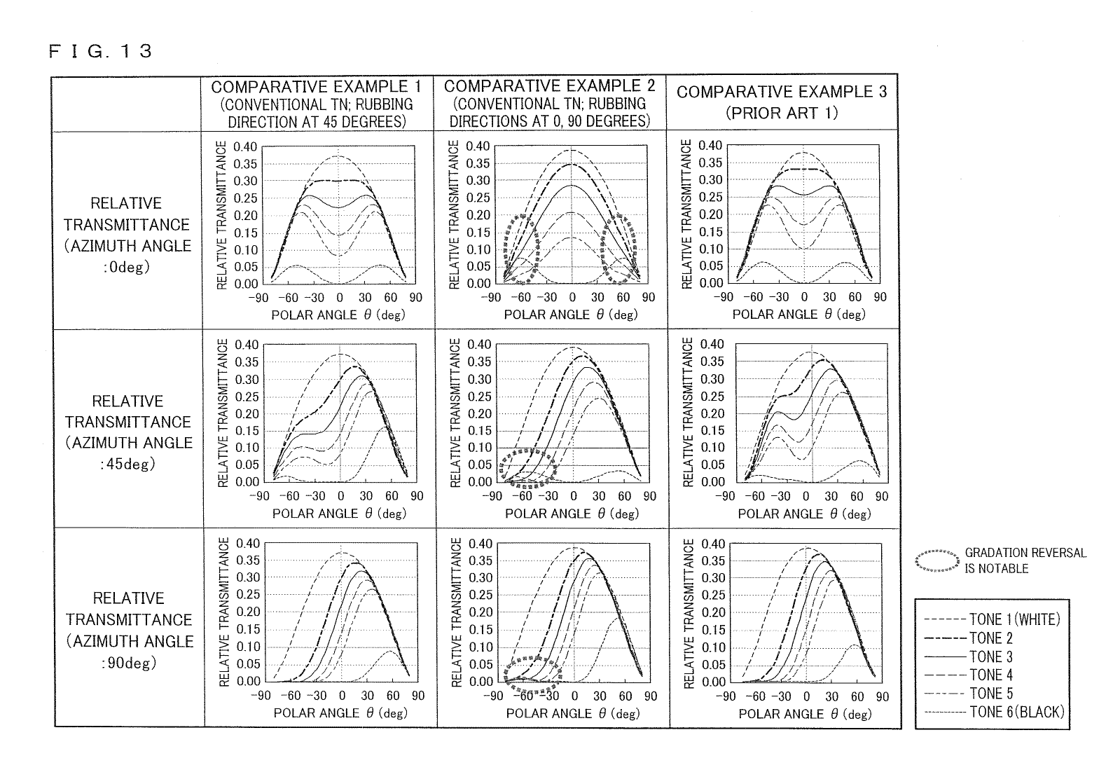

It is possible to know how the provision of the biaxial phase plate affects the polar angle-transmittance characteristic illustrated in FIGS. 11 and 13, by comparing (i) Configuration Examples 1 through 3 and (ii) Comparative Example 2. Specifically, according to the conventional TN display liquid crystal display device which includes no biaxial phase plate, there occurred areas (see areas each encircled by dotted line) where the polar angle-transmittance characteristics notably overlap one another for two or more tones. In contrast, according to the liquid crystal display device of the present invention in which a biaxial phase plate is provided in accordance with the predetermined optical axis settings, such areas where the polar angle-transmittance characteristics overlap one another are eliminated. It was thus confirmed that a gradation reversal phenomenon could be greatly improved for halftones.

It is possible to know how the viewing angle characteristic is affected by the arrangement relation between the in-plane slow axis of the biaxial phase plate and the absorption axis of the polarizing plate, by comparing equal-contrast curves of (i) Configuration Example 1 and (ii) Comparative Example 3 shown in FIG. 10. In a case where (i) an absorption axis and an in-plane slow axis provided on an upper side of the liquid crystal panel are perpendicular to each other and (ii) an absorption axis and an in-plane slow axis provided on a lower side of the liquid crystal panel are perpendicular to each other (see (a) of FIG. 1), it was confirmed that a symmetric property of, in particular, right to left direction could be more improved, as compared to a case where an absorption axis and an in-plane slow axis provided on a lower side of the liquid crystal panel are perpendicular to each other and an absorption axis and an in-plane slow axis provided on an upper side of the liquid crystal panel are in parallel with each other (see FIG. 17). This reveals that it is possible to drastically improve a right and left symmetric property of the viewing angle characteristics.

From comparison between (i) Configuration Examples 1 through 6 and (ii) Comparative Example 3 in terms of a black chromaticity characteristic and a variation in black chromaticity shown in FIGS. 14 and 15, it was confirmed that, in the case where the biaxial phase plates are provided on the upper and lower sides in accordance with the predetermined design as in the present invention, excellent black chromaticity characteristic could be obtained and a color variation in the black chromaticity could be reduced, without surrendering the advantage of the symmetric property of the viewing angle characteristic. This was notably confirmed in Configuration Examples 1 and 4.

It is possible to deduce effects brought by the arrangement of the present invention in which an absorption axis of the polarizing plate is at an angle of 45 degrees to a rubbing direction of a corresponding substrate, by comparing the polar angle-transmittance characteristics and/or the equal-contrast curves between (i) Configuration Example 1 or Comparative Example 1 in which the absorption axis of the polarizing plate is at an angle of 45 degrees to the rubbing direction and (ii) Comparative Example 2 in which the absorption axis of the polarizing plate is at an angle of 0 degree or 90 degrees (see FIGS. 10, 11, and 13).

That is, a gradation reversal in a halftone display can be drastically and notably improved and therefore display quality can be improved, in an configuration of the present invention in which the absorption axis of the polarizing plate is at an angle of 45 degrees to the rubbing direction, as compared to the case of the conventional TN display liquid crystal display device in which the absorption axis of the polarizing plate is in parallel with (at an angle of 0 degree to) or perpendicular to (at an angle of 90 degrees to) the rubbing direction.

When Configuration Example 1 and Comparative Example 1 are compared with each other in which each of the absorption axes of the respective polarizing plates and the corresponding rubbing direction forms an angle of 45 degrees, a symmetric property of a halftone display in an oblique direction (e.g., a direction at an azimuth angle of 45 degrees) is better in Configuration Example 1 in which the biaxial phase plates are arranged based on a predetermined optical axis design than Comparative Example 1 (see FIG. 11), and a black display characteristic such as a color variation in black chromaticity is more excellent in Configuration Example 1 than Comparative Example 1 (see FIG. 14). Accordingly, a black display can be improved and a stabled high contrast display can be realized in Configuration Example 1 of the present invention.

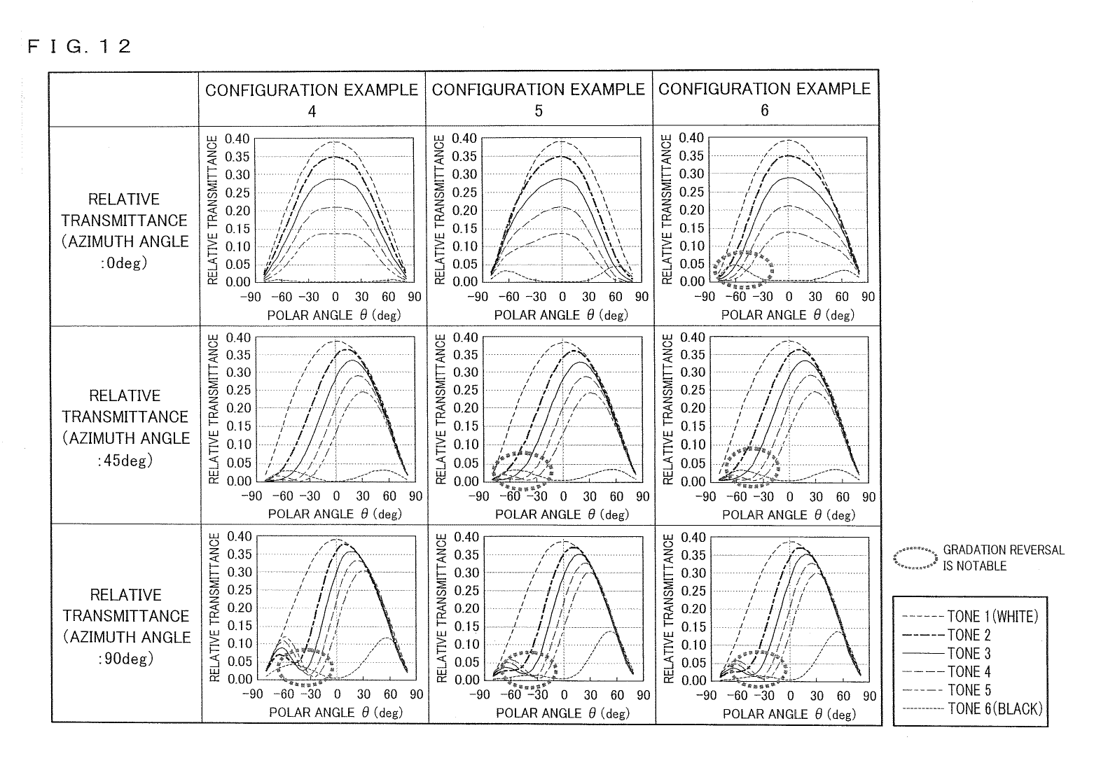

On the other hand, it can be confirmed that areas where the polar angle-transmittance characteristics notably overlap one another for two or more tones are decreased in Configuration Examples 4, 5, and 6 (see areas each encircled by dotted ellipses in FIGS. 12 and 13), by comparing Comparative Example 2, in which a general TN display liquid crystal display device is described, with Configuration Examples 4, 5, and 6 of the present invention in which the biaxial phase plate(s) is arranged based on the predetermined optical axis design. This shows that the configurations of Configuration Examples 4, 5, and 6 can improve a viewing angle characteristic.

According to Configuration Example 4 in which the biaxial phase plates are provided on respective upper and lower sides, it is confirmed that a wider range of viewing angle characteristic can be realized while a symmetric property of an equal-contrast curve is maintained, as compared with Comparative Example 2 in terms of the equal-contrast curve shown in FIG. 10.

For the reasons described above, the configurations of the present invention can bring about higher effect of improving display quality.

From the results, it is confirmed that a variation in chromaticity in a black display depending on viewing angle directions can be notably suppressed by the configuration of the present invention in which the biaxial phase plates are provided on the respective upper and lower sides based on the predetermined design, as compared to the conventional TN display liquid crystal display device and the prior art. Accordingly, it is possible to (i) reduce steep variation in a black level occurred depending on viewing angle directions and (ii) improve a decrease of a contrast ratio.

In particular, Configuration Example 1 is the best mode of the present invention in view of the results concerning properties such as the viewing angle characteristic (improvement in a gradation reversal in a halftone, the equal-contrast characteristic, and the symmetric property), and the variations in the black chromaticity and in a distance between colors.

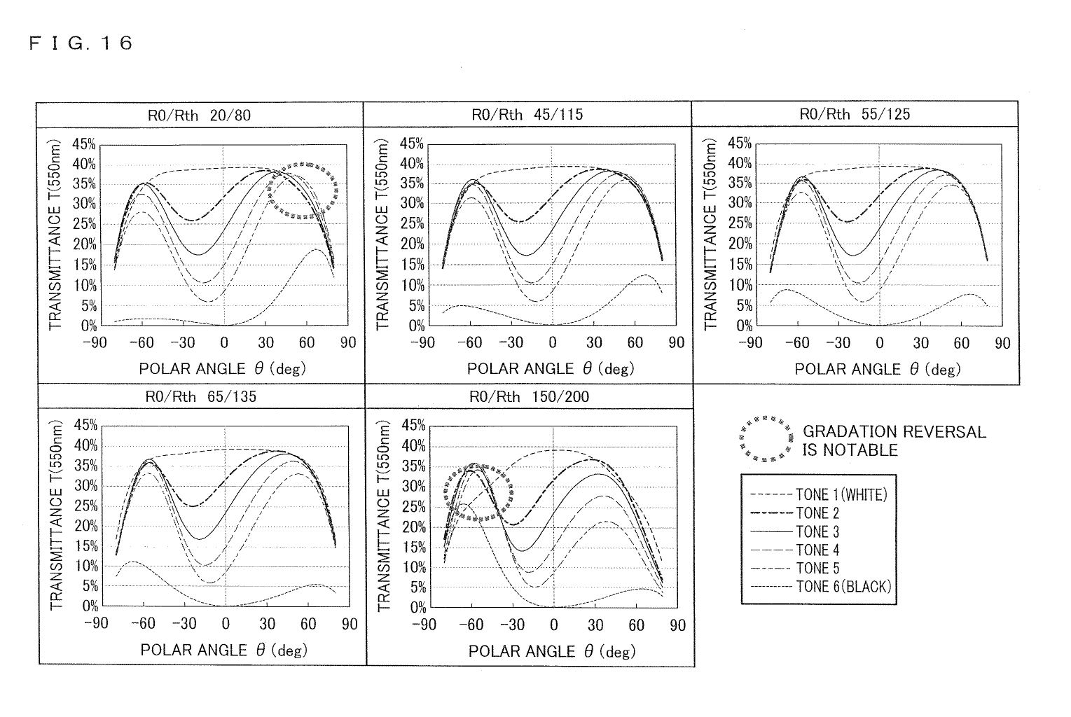

Lastly, a more preferable condition was confirmed regarding a phase difference characteristic of the biaxial phase plate of the present invention. In this confirmation, an in-plane phase difference R₀ of the biaxial phase plate provided on each of the upper and lower substrates and a normal phase difference Rₜₕ in a thickness direction were evaluated, by changing the values of R₀/Rₜₕ within a range between 20 nm/80 nm and 150 nm/200 nm, as a polar angle-relative transmittance characteristic at an azimuth angle of +45 degrees. FIG. 16 illustrates the results of the evaluation.

Note that the in-plane phase difference R₀ and the normal phase difference Rₜₕ are defined as follows with the use of the main refractive indexes nx, ny, and nz of the biaxial phase plate and the thickness d (nm) of the biaxial phase plate:

R₀=(nx−ny)·d

Rₜₕ={(nx+ny)/2−nz}·d

From the results shown in FIG. 16, it is confirmed that the polar angle-transmittance characteristics of two or more tones notably overlap each other (see areas each encircled by doted line) and gradation reversals occur, in the cases where the values R₀/Rₜₕ are 20 nm/80 nm, and 150 nm/200 nm.

From this result, in a case where the in-plane phase difference R₀ falls within the range between 45 nm and 65 nm and the normal phase difference Rₜₕ falls within the range between 115 nm and 135 nm, it is confirmed that a gradation reversal does not occur, and therefore the viewing angle characteristic becomes excellent. On the other hand, in a case where the in-plane phase difference R₀ and the normal phase difference Rₜₕ do not fall within the above described respective ranges, a gradation reversal remarkably tends to occur and the viewing angle characteristic to become worse.

According to the liquid crystal display device of the present invention in which the biaxial phase plates are arranged based on the predetermined arrangements of optical axes, the display characteristic such as the symmetric property of the viewing angle can be notably improved. Further, it is also confirmed that the configuration of the present invention drastically improves the variation in black chromaticity which affects the contrast ratio characteristic.

Further, according to the present invention, a polarizing plate member with a biaxial phase plate which is used in a VA display liquid crystal display device for improving its display characteristic can be also used in a TN display liquid crystal display device, whereby an unused material can be reduced. This makes it possible to drastically improve area use efficiency of a polarizing plate, and therefore costs of materials can be further reduced.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention can be applied to a liquid crystal display device which can be stably manufactured and is aiming to realize a low price. More specifically, the present invention can be widely applied to (i) a small/medium sized liquid crystal display devices such as a mobile phone, a portable information device (PDA), and a portable game device, or (ii) a cheap general-purpose liquid crystal display device for use in a personal computer, etc.

### REFERENCE SIGNS LIST

1: Liquid crystal display device
1A: Liquid crystal display device
1B: Liquid crystal display device
2a: First substrate
2b: Second substrate
3: Liquid crystal molecule
4a: Polarizing plate (first polarizing plate)
4b: Polarizing plate (second polarizing plate)
5a: Biaxial phase plate
5b: Biaxial phase plate
6a and 6b: Rubbing direction
4α and 4β: Absorption axis
5α, 5β, and 5γ: In-plane slow axis
10: Liquid crystal layer
100: Liquid crystal panel
100A: Liquid crystal panel
100a: First substrate
100b: Second substrate
112a and 112b: Polarizing plate
113a and 113b: Biaxial phase plate
114: Liquid crystal molecule
115a and 115b: Rubbing direction
150: Liquid crystal display device
a(o): Absorption axis of polarizing plate
e1(o): In-plane slow axis

1. A liquid crystal display device comprising:
a pair of a first substrate and a second substrate, the first substrate being provided on a viewer side;
a liquid crystal layer which is provided between the first substrate and the second substrate, the liquid crystal layer being a twisted nematic liquid crystal layer which has substantially 90-degree twist, in a thickness direction, between the first substrate and the second substrate;
a pair of a first polarizing plate and a second polarizing plate having respective absorption axes which are perpendicular to each other, the first polarizing plate and the second polarizing plate being provided on outer sides of the respective first and second substrates; and
a biaxial phase plate which is provided between the first polarizing plate and the second polarizing plate,
the biaxial phase plate including first and second biaxial phase plates which are provided for the respective first and second polarizing plates so that their in-plane slow axes are substantially perpendicular to each other,
the absorption axis of the first polarizing plate being set to be at an angle of substantially 90 degrees to an in-plane slow axis of the first biaxial phase plate, and
the absorption axis of the second polarizing plate being set to be at an angle of substantially 90 degrees to an in-plane slow axis of the second biaxial phase plate.

2. A liquid crystal display device comprising:
a pair of a first substrate and a second substrate, the first substrate being provided on a viewer side;
a liquid crystal layer which is provided between the first substrate and the second substrate, the liquid crystal layer being a twisted nematic liquid crystal layer which has substantially 90-degree twist, in a thickness direction, between the first substrate and the second substrate;
a pair of a first polarizing plate and a second polarizing plate having respective absorption axes which are perpendicular to each other, the first polarizing plate and the second polarizing plate being provided on outer sides of the respective first and the second substrates; and
a biaxial phase plate which is provided at least one of (i) between the first substrate and the first polarizing plate and (ii) between the second substrate and the second polarizing plate,
an in-plane slow axis of the biaxial phase plate being set to be at an angle of substantially 90 degrees to an absorption axis of a corresponding one of the first polarizing plate and the second polarizing plate on which the biaxial phase plate is provided.

3. The liquid crystal display device as set forth in claim 1, wherein:
the absorption axis of the first polarizing plate is set to be at an angle of substantially 45 degrees to a rubbing direction of the first substrate; and
the absorption axis of the second polarizing plate is set to be at an angle of substantially 45 degrees to a rubbing direction of the second substrate.

4. The liquid crystal display device as set forth in claim 3, wherein:
the biaxial phase plate is provided between the second substrate and the second polarizing plate.

5. The liquid crystal display device as set forth in claim 1, wherein:
the biaxial phase plate has (i) an in-plane phase difference R₀ which falls within a range between 45 nm and 65 nm, the in-plane phase difference R₀ being defined by Formula 1 below and (ii) a normal phase difference Rₜₕ in a thickness direction which normal phase difference Rₜₕ falls within a range between 115 nm and 135 nm, the normal phase difference Rₜₕ being defined by Formula 2 below,
R₀=(nx−ny)·d (Formula 1)
Rₜₕ{(nx+ny)/2−nz}·d (Formula 2)
where x and y are in-plane directions of the biaxial phase plate which are perpendicular to each other; z is a thickness direction of the biaxial phase plate; nx, ny, and nz are main refractive indexes, at 25° C., for the respective directions x, y, and z; and d (nm) is a thickness of the biaxial phase plate.

6. The liquid crystal display device as set forth in claim 1, wherein:
the liquid crystal layer has a phase difference which falls within a range between 400 nm and 470 nm, on condition of a temperature of 25° C. and a wavelength of 550 nm.

7. The liquid crystal display device as set forth in claim 2, wherein:
the absorption axis of the first polarizing plate is set to be at an angle of substantially 45 degrees to a rubbing direction of the first substrate; and
the absorption axis of the second polarizing plate is set to be at an angle of substantially 45 degrees to a rubbing direction of the second substrate.

8. The liquid crystal display device as set forth in claim 2, wherein:
the biaxial phase plate is provided between the second substrate and the second polarizing plate.

9. The liquid crystal display device as set forth in claim 2, wherein:
the biaxial phase plate has (i) an in-plane phase difference R₀ which falls within a range between 45 nm and 65 nm, the in-plane phase difference R₀ being defined by Formula 1 below and (ii) a normal phase difference Rₜₕ in a thickness direction which normal phase difference Rₜₕ falls within a range between 115 nm and 135 nm, the normal phase difference Rₜₕ being defined by Formula 2 below,
R₀=(nx−ny)·d (Formula 1)
Rₜₕ={(nx+ny)/2−nz}·d (Formula 2)
where x and y are in-plane directions of the biaxial phase plate which are perpendicular to each other; z is a thickness direction of the biaxial phase plate; nx, ny, and nz are main refractive indexes, at 25° C., for the respective directions x, y, and z; and d (nm) is a thickness of the biaxial phase plate.

10. The liquid crystal display device as set forth in claim 2, wherein:
the liquid crystal layer has a phase difference which falls within a range between 400 nm and 470 nm, on condition of a temperature of 25° C. and a wavelength of 550 nm.
